(19) United States
(12) Patent Application Publication
(10) Pub. No.: US 2026/0299112 A1
(43) Pub. Date: Oct. 1, 2026

(54) NOTCH-BASED SLIP ANGLE ESTIMATION FOR GROUND SPEED RADARS

(71) Applicant: VOLVO TRUCK CORPORATION, Göteborg (SE)

(72) Inventors: Mats RYDSTRÖM, Billdal (SE); Axel CEDER, Göteborg (SE)

(73) Assignee: VOLVO TRUCK CORPORATION, Göteborg (SE)

(21) Appl. No.: 19/476,960

(22) PCT Filed: Apr. 18, 2023
(86) PCT No.: PCT/EP2023/060010

§ 371 Date: Oct. 20, 2025

(51) Int. Cl. G01S 13/58; G01S 7/35; G01S 13/60; G01S 13/931

(52) U.S. Cl. CPC G01S 13/584; G01S 7/354; G01S 13/60; G01S 13/931; G01S 2013/932

(57) ABSTRACT

A radar system determines at least one slip angle of a heavy-duty vehicle with respect to a ground plane supporting the vehicle. The radar system has at least one radar transceiver arranged to transmit and to receive a radar signal via an antenna array, over a range of azimuth directions, and processing circuitry arranged to evaluate a received non-zero Doppler power over the range of azimuth directions. The processing circuitry is arranged to determine a slip angle of the heavy-duty vehicle as the azimuth direction associated with smallest received non-zero Doppler power over the range of azimuth directions.

### TECHNICAL FIELD

This disclosure relates generally to vehicle motion estimation, i.e., the determination of one or more variables of a vehicle motion state, such as speed and acceleration in one or more directions. In particular aspects, the disclosure relates to radar systems for determining vehicle speed over ground. The technologies of the disclosure can be applied in heavy-duty vehicles, such as trucks, buses, and construction equipment, among other vehicle types. Although the disclosure may be described with respect to a particular vehicle, the disclosure is not restricted to any particular vehicle.

### BACKGROUND

Modern heavy-duty vehicles often comprise advanced vehicle motion management (VMM) systems that assist the driver in controlling the vehicle, e.g., during hard braking and in other advanced maneuvers. Some vehicles are even capable of operating autonomously, without a human driver. These types of VMM systems rely heavily on the availability of accurate information about the vehicle motion state, such as the speed and acceleration of the vehicle.

ISO 26262, titled “Road vehicles-Functional safety”, is an international standard for functional safety of electrical and/or electronic systems that are installed in serial production road vehicles (excluding mopeds). It was defined by the International Organization for Standardization (ISO) in 2011 and revised in 2018. In the light of ISO 26262, it has been proposed that vehicle motion state estimation outliers, i.e., large errors creating hazards, only should be acceptable once per 10\hat{ }8 hours of driving. It is a challenge to meet these strict target requirements.

Inertial measurements units (IMU) and wheel speed sensors have traditionally been relied upon to provide information about motion state of heavy-duty vehicles. However, more reliable sensor systems are desired, and there is a particular need for redundant motion sensor systems.

### SUMMARY

It is an objective of the present disclosure to provide improved systems and methods for determining the speed over ground of a heavy-duty vehicle. This objective is at least in part obtained by radar system configured to determine at least one slip angle of a heavy-duty vehicle with respect to a ground plane supporting the vehicle. The radar system comprises at least one radar transceiver arranged to transmit and to receive a radar signal via an antenna array over a range of azimuth directions The radar system also comprises processing circuitry arranged to evaluate a received non-zero Doppler power over the range of azimuth directions, and to determine the slip angle of the heavy-duty vehicle as the azimuth direction associated with smallest received non-zero Doppler power over the range of azimuth directions. This way an estimate of slip angle can be obtained which does not rely on detection of radial velocities. The slip angle can be determined in a reliable manner using this technique. It is appreciated that a maximization of received zero Doppler radar signal power over the range A of azimuth directions is equivalent to the aforementioned minimization of received non-zero Doppler power over the range A of azimuth directions. The processing circuitry is optionally configured to trigger at least one automated action by the vehicle based on the determined slip angle, such as a configuration of vehicle operational design domain, allowed range of vehicle motion states (maximum velocity, curvature, etc), and so on.

According to some aspects, the processing circuitry is arranged to evaluate the received non-zero Doppler power over the range of azimuth directions for a given range. This reduces the computational burden, and in many cases also improves the accuracy of the determined side slip since some clutter can be disregarded.

The range of azimuth directions may be a set of discrete azimuth directions or a continuous range of azimuth directions. The technique can be applied with radar systems implementing detection in discrete azimuth directions, i.e., by FFT processing, or in a continuous range as, e.g., a steered antenna lobe system.

According to some aspects, the antenna array is configured to emit the radar signal in a transmission lobe simultaneously covering the range of azimuth directions. This has the added advantage of enabling monitoring of all angles simultaneously. However, it is also possible to emit the radar signal in a transmission lobe which is more narrow than the range of azimuth directions, and to sweep the transmission lobe over the range of azimuth directions. In this way the transmit power becomes more spatially focused, which can improve the signal to noise ratio of the received radar backscatter. The processing circuitry can be arranged to steer the transmission lobe of the radar system to minimize the received non-zero Doppler power over the range of azimuth directions, or, equivalently to maximize the received zero Doppler radar signal power over the range A of azimuth directions.

According to some aspects, the processing circuitry is arranged to validate an estimated longitudinal and lateral velocity based on the determined slip angle of the heavy-duty vehicle. This validation is a sanity check on the estimated vehicle motion state, and therefore improves vehicle motion state estimation reliability. The processing circuitry can also be arranged to trigger generation of a notification message in case a difference between the determined slip angle and the angle of the estimated longitudinal and lateral velocity does not fulfil some sort of predetermined acceptance criterion, such as a threshold, a statistical acceptance test, or the like.

According to some aspects, the processing circuitry is arranged to obtain data associated with a steering angle of a wheel of the heavy-duty vehicle, and to transform the determined slip angle of the heavy-duty vehicle into a coordinate system of the wheel based on the data associated with the steering angle of the wheel. This way the radar system can be used as a stand-alone sensor of slip angle, compatible also with legacy vehicles that lack advanced VMM functionality. The function also reduces the computational burden on other systems using the side slip data determined by the radar system.

The processing circuitry is optionally arranged to calibrate the determined slip angle of the heavy-duty vehicle based on input from at least one other sensor system. This way the output from the radar sensor system becomes more reliable. The calibration may be triggered manually or be performed automatically. The at least one other sensor system may, e.g., comprise wheel speed sensors of a wheel axle.

According to some aspects, the processing circuitry is arranged to adapt a shape of an antenna lobe of the radar transceiver in dependence of an operating condition of the vehicle. This can improve performance off the radar system in some use cases. The processing circuitry may also be arranged to adapt an elevation angle of the antenna lobe to improve performance of the radar system.

The disclosed aspects, technical features, and examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

The above, as well as additional objects, features, and advantages, will be better understood through the following illustrative and non-limiting detailed description of exemplary embodiments, wherein:

FIG. 1 illustrates an example vehicle with a ground radar system;

FIG. 2 is a graph showing example longitudinal tyre forces as function of longitudinal tyre slip;

FIG. 3 shows an example motion support device control arrangement;

FIG. 4 illustrates another example vehicle with a ground radar system;

FIG. 5 illustrates an example vehicle control function architecture;

FIGS. 6A-B illustrate example antenna arrays for ground radar systems;

FIGS. 7A-B show example antenna radiation diagrams;

FIGS. 8A-B show radar transmission using wide and narrow example lobes;

FIG. 9 exemplifies variable elevation angle radar transmission;

FIG. 10 shows angle of arrival processing of an antenna array signal;

FIG. 11 illustrates received radar signal power;

FIG. 12 shows a dual band ground penetrating radar system;

FIG. 13 illustrate aspects of a dual band ground radar system;

FIG. 14 exemplifies antenna lobes of a dual band ground radar system;

FIG. 15A shows a range-Doppler map for an example radar signal;

FIG. 15B shows another range-Doppler map for a radar signal;

FIG. 16 illustrates a notch-based slip angle estimation principle;

FIG. 17 illustrates an example vehicle with a ground radar system;

FIG. 18 illustrates a virtual Janus configuration ground radar system;

FIG. 19 illustrates an effect of pitch motion on radial velocity;

FIG. 20 illustrates a virtual Janus configuration ground radar system;

FIG. 21 schematically illustrates a vehicle model;

FIGS. 22A-D are flow charts illustrating methods; and

FIG. 23 shows an example computer system.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference characters refer to like elements throughout the description.

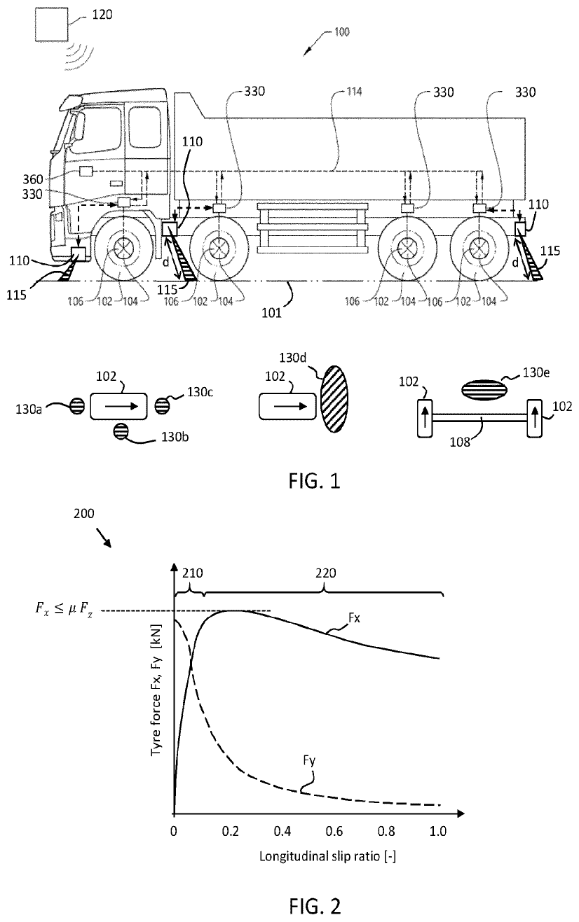

FIG. 1 illustrates an example heavy-duty vehicle 100, here in the form of a truck. A heavy-duty vehicle may be taken to mean a motor vehicle rated at more than 8,500 pounds Gross Vehicle Weight Rating (GVWR), which is about 3850 kg, or that has a vehicle curb weight of more than 6,000 pounds (about 2700 kg), or that has a basic vehicle frontal area in excess of 45 square feet (about 4.2 square meters). A heavy-duty vehicle may also be taken to mean a motor vehicle having GVWR in excess of 7.5 tons.

It is appreciated that the herein disclosed methods and control units can be applied with advantage also in other types of heavy-duty vehicles, such as trucks with drawbar connections, construction equipment, buses, and the like. The vehicle 100 may also comprise more than two vehicle units, i.e., a dolly vehicle unit may be used to tow more than one trailer. Some aspects of the herein proposed techniques are particularly suitable for articulated vehicles such as semi-trailers. Aspects of the disclosure may also be implemented in smaller vehicles such as passenger cars and the like.

The vehicle 100 comprises a plurality of wheels 102, and at least a subset of the wheels 102 comprise or is associated with at least one motion support device (MSD) 104. The MSDs 104 may be arranged for generating a torque on a wheel of the vehicle or for both wheels of an axle. The MSD may be a propulsion device, such as an electric machine 106 arranged to, e.g., provide a longitudinal wheel force to the wheel(s) of the vehicle 100. Such an electric machine may thus be adapted to generate a propulsion torque as well as to be arranged in a regenerative braking mode for electrically charging a battery (not shown) or other energy storage system(s) of the vehicle 100. The MSDs 104 may also comprise friction brakes such as disc brakes or drum brakes arranged to generate a braking torque by the wheel 102 in order to decelerate the vehicle, or power steering systems for generating a steering effect.

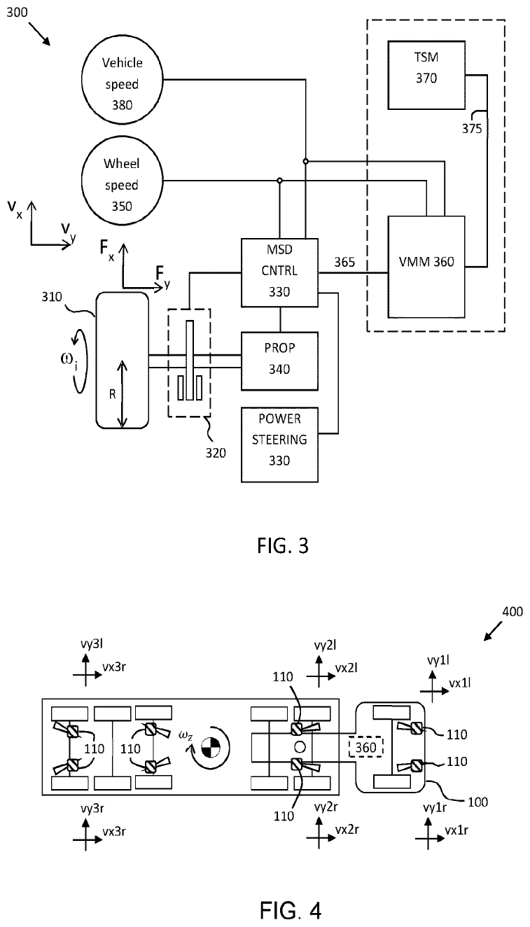

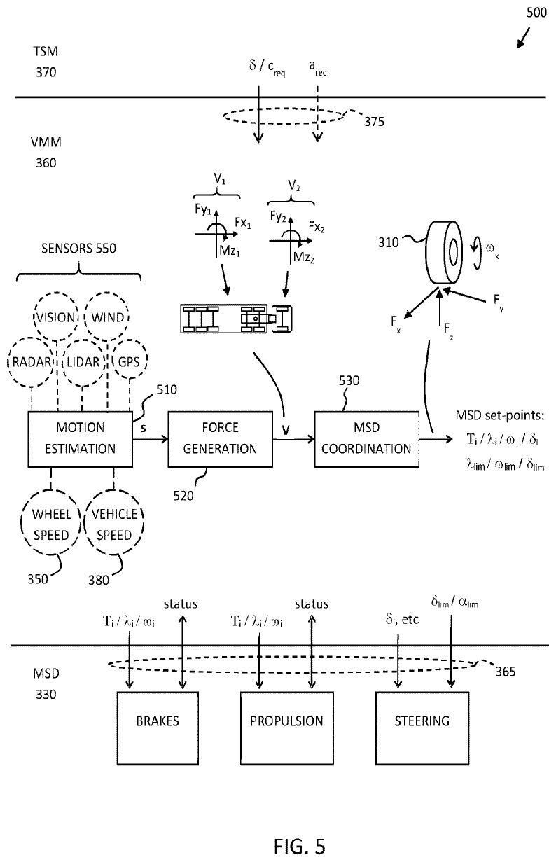

Each of the MSDs 104 is connected to a respective MSD control system or control unit 330 arranged for controlling operation of the MSD 104. The MSD control system 330 is preferably a decentralized motion support system 330, although centralized implementations are also possible. It is furthermore appreciated that some parts of the MSD control system may be implemented on processing circuitry remote from the vehicle, such as on a remote server 120 accessible from the vehicle via wireless link. Still further, each MSD control system 330 is connected to a VMM function 360 of the vehicle 100 via a data bus communication arrangement 114 that can be either wired, wireless or both wired and wireless. Hereby, control signals can be transmitted between the vehicle motion management system 360 and the MSD control system 330. In addition, the MSDs may also inform the VMM function 360 about their actual state, e.g., the instantaneous actual torque that have been applied or the steering angle which is currently targeted by the actuator. The VMM function 360 and the MSD control system 330 will be described in further detail below with reference to FIG. 3 and FIG. 5.

The vehicle 100 comprises a number of radar transceivers 110 arranged to transmit respective radar signals 115 towards the road surface 101 that supports the vehicle 100, which road surface may also be referred to as a ground plane. It is appreciated that the road surface is not perfectly planar, although in most cases a planar assumption is sufficiently accurate for the purpose of vehicle motion estimation. The radar transceivers 110 form an important part of the motion estimation system of the vehicle 100 and will be discussed at length below. The vehicle 100 may also comprise other types of sensors, such as inertial measurement units (IMU) and wheel speed sensors, as well as vision-based sensors and satellite positioning receivers.

Longitudinal wheel slip λ_{x,i} for the i-th wheel on the vehicle 100 may, in accordance with SAE J370 (SAE Vehicle Dynamics Standards Committee Jan. 24, 2008) be defined as

$${λ}_{x} = \frac{R {ω}_{i} - {v}_{x}}{max ( \vert R {ω}_{i} \vert , \vert {v}_{x} \vert )}$$

where R is an effective wheel radius in meters, ωᵢ is the angular velocity of the i-th wheel on the vehicle 100, and vₓ is the longitudinal speed of the wheel (in the coordinate system of the wheel). Thus, λₓ is bounded between −1 and 1 and quantifies how much the wheel is slipping with respect to the road surface. Both terms refer to the surface supporting the vehicle 100, which is also the reference for the vehicle speed over ground in lateral and longitudinal directions. Wheel slip is, in essence, a speed difference measured between the tyre circumference and the vehicle but normalized with speed. Thus, the herein disclosed techniques can be adapted for use with any type of wheel slip definition. It is also appreciated that a wheel slip value is equivalent to a wheel speed value given a velocity of the wheel over the surface, in the coordinate system of the wheel. The VMM 360 and optionally also the MSD control system 330 maintains information on vₓ in the reference frame of the wheel, while a wheel speed sensor or the like can be used to determine ωᵢ.

Slip angle α, also known as sideslip angle, is the angle between the direction in which a wheel is pointing and the direction in which it is actually traveling (i.e., the angle between the longitudinal velocity component vₓ and the vector sum of wheel forward velocity vₓ and lateral velocity v_{y}. This slip angle results in a force, the cornering/lateral force, which is in the plane of the contact patch and perpendicular to the intersection of the contact patch and the midplane of the wheel. The cornering force increases approximately linearly for the first few degrees of slip angle, then increases non-linearly to a maximum before beginning to decrease again. The slip angle α is often defined as

$$α = arctan ( \frac{{v}_{y}}{\vert {v}_{x} \vert} )$$

where v_{y} is the lateral speed of the wheel in the coordinate system of the wheel.

It is noted that the subscript i in λ_{x,i}, v_{x,i}, Rᵢ and αᵢ has been dropped to simplify the disclosure. It is, however, appreciate that these quantities are associated with a given wheel on the vehicle in question.

In order for a wheel (or tyre) to produce a wheel force which affects the motion state of the heavy-duty vehicle, such as an acceleration, wheel slip must occur. For smaller slip values the relationship between slip and generated force is approximately linear, where the proportionality constant is often denoted as the slip stiffness Cₓ of the tyre. A tyre is subject to a longitudinal force Fₓ, a lateral force F_{y}, and a normal force F_{z}. The normal force F_{z} is key to determining some important vehicle properties. For instance, the normal force to a large extent determines the achievable longitudinal tyre force Fₓ by the wheel since, normally, Fₓ≤μF_{z}, where μ is a friction coefficient associated with a road friction condition. The maximum available lateral force for a given wheel slip can be described by the so-called Magic Formula as described in “Tyre and vehicle dynamics”, Elsevier Ltd. 2012, ISBN 978-0-08-097016-5, by Hans Pacejka, where wheel slip and tyre force is also discussed in detail. Moreover, when the tyre force is not saturated the linear relation between slip and force is also influenced by the normal force.

FIG. 2 is a graph showing an example 200 of achievable tyre forces as function of longitudinal wheel slip. Fₓ is the longitudinal tyre force while F_{y} is the maximum obtainable lateral wheel force for a given wheel slip. This type of relationship between wheel slip and generated tyre force is often referred to as an inverse tyre model, and it is generally known. Since the tyre characteristics are not monotonically growing for larger slip values, the inverse tyre model does not exist for all slip values. Therefore, the inverse is normally taken from zero force up to the peak force. The examples in FIG. 2 are for positive wheel forces, i.e., acceleration. Similar relationships exist between wheel slip and negative wheel force, i.e., braking.

An inverse tyre model like the relationship in FIG. 2 can be used to translate between a desired longitudinal tyre force Fₓ and longitudinal wheel slip λₓ. The interface between VMM and MSDs capable of delivering torque to the vehicle's wheels has as mentioned above traditionally been focused on torque-based requests to each MSD from the VMM without any consideration towards wheel slip. However, this approach has some performance limitations. In case a safety critical or excessive slip situation arises, then a relevant safety function (traction control, anti-lock brakes, etc.) operated on a separate control unit normally steps in and requests a torque override in order to bring the slip back into control. The problem with this approach is that since the primary control of the actuator and the slip control of the actuator are allocated to different electronic control units (ECUs), the latencies involved in the communication between them significantly limits the slip control performance. Moreover, the related actuator and slip assumptions made in the two ECUs that are used to achieve the actual slip control can be inconsistent and this in turn can lead to sub-optimal performance. Significant benefits can be achieved by instead using a wheel speed or wheel slip-based request on the interface between VMM 360 and the MSD controller or controllers 330, thereby shifting the difficult actuator speed control loop to the MSD controllers, which generally operate with a much shorter sample time compared to that of the VMM system. Such an architecture can provide much better disturbance rejection compared to a torque-based control interface and thus improves the predictability of the forces generated at the tyre road contact patch.

A problem encountered when using wheel slip to actively control one or more wheels on a heavy-duty vehicle, such as the vehicle 100, and also when executing more low complex control such as imposing a wheel slip limit locally at wheel end, is that the speed over ground vₓ of the wheel (and of the vehicle) may not be accurately known. For instance, if wheel speed sensors such as Hall effect sensors or rotational encoders are used to determine vehicle speed over ground, then the vehicle speed over ground will be erroneously determined in case the wheels used for estimating the speed over ground are themselves slipping. In addition, the tyre radii of the vehicle 100 may not be known with sufficient accuracy. Also, vehicle speed over ground determined based on wheel rotation is one-dimensional, i.e., the method does not allow determining a wheel lateral speed over ground v_{y} in addition to the longitudinal speed over ground vₓ, i.e., a speed vector in two dimensions. This of course makes estimating the sideslip angle α challenging.

Satellite based positioning systems can be used to determine the speed over ground of a heavy-duty vehicle 100 and of any given wheel on the vehicle 100. However, these systems do not function well in some environments, such as environments without a clear view of the sky. Multipath propagation of the satellite radio signals can also induce large errors in the estimated vehicle position, which then translates into errors in the estimated vehicle speed over ground.

Vision-based sensor systems and radar systems can also be used to determine vehicle speed over ground. However, such systems are relatively costly and not always without issues when it comes to accuracy and reliability. Vision-based sensor may for instance suffer from performance degradation due to sun glare while radar sensor systems may be prone to interference from other radar transceivers.

Aspects of the present disclosure proposes the use of radar to determine both longitudinal and lateral velocity of a vehicle with respect to ground. With reference to FIG. 1, each radar module 110 can be configured to determine a velocity of the vehicle 100 relative to the road surface at the location of the radar transceiver, based on the received backscatter of the radar signal 115 transmitted towards the road surface. The determined velocity can be one-dimensional, such as a longitudinal velocity vₓ of the vehicle, or a two-dimensional velocity vector [vₓ, v_{y}] with respect to the road surface 101 supporting the vehicle 100. Some of the radar systems discussed herein also determine the distance d from the radar 110 to the road surface 101, as shown in FIG. 1.

The radar transceivers 110 on the vehicle 100 may illuminate one or more small portions 130a, 130b, 130c of the road surface, as exemplified by the illustrations at the bottom of FIG. 1, left, or a larger portion 130d as in the illustration at the bottom of FIG. 1, middle. Various illumination patterns can be selected (both smaller area and larger area). It may be an advantage if the illuminated portion of the ground surface by a given radar transceiver is close to a wheel and relatively small in size since this improves the received signal power of the radar signal components. A larger illuminated area on the other hand becomes less sensitive to unevenness in the road surface, such as potholes and the like, since it provides an averaging effect which can be desired in some cases. Some of the techniques disclosed herein relate to radar transceivers with antenna arrays that are configured to adjust a size and shape of the illuminated area in dependence of an operating condition of the vehicle 100. The illuminated area of these radar system may, e.g., quickly be expanded in size if the radar signal becomes distorted due to unevenness in the road surface.

As shown in FIG. 1, the illuminated portion of the road surface 101 can be directly behind 130a the contact patch of a wheel 102, to the side 130b of the contact patch of the wheel 102, or in front 130c, 130d of the contact patch of the wheel 102. An illuminated portion of road surface 130e can also be centered on an axle, as shown in the insert to the right in FIG. 1. The illuminated portion of road surface is preferably within 1 m of the contact patch of a wheel, since this allows a better idea of how the wheel is moving relative to the road surface. The illuminated portion of road surface is even more preferably within 0.5 m of the contact patch of a wheel. This way the speed over ground detected by the radar becomes more closely linked to the actual speed over ground by the wheel 102 and/or wheel axle 108, since the illuminated portion of road surface 130a-e is at a short distance from the wheel 102 and/or from the axle 108.

A radar transceiver 110 is arranged to transmit the radar signal 115 over a radar bandwidth, where a larger bandwidth improves range resolution in a known manner.

Velocity resolution depends on the radar wavelength and the repetition period of the waveform in a known manner. According to some aspects, the transceiver is arranged to transmit a frequency modulated continuous wave (FMCW) radar signal over the radar bandwidth, where a frequency chirp is swept over the radar bandwidth in cycles. Other types of radar signal formats may also be used, such as band-spread radar signals where orthogonal codes are used to spread a modulated signal over a wide frequency band, or an orthogonal frequency division multiplexed (OFDM) radar signal. Given an FMCW radar signal format, the distance to the road surface 101 (and also to reflecting material under the road surface) may be determined based on a first Discrete Fourier Transform (DFT), or Fast Fourier Transform (FFT), and the radial velocity or Doppler frequency of the illuminated portion of ground may be determined based on a second DFT or FFT, in a known manner. The result of applying a range FFT and a Doppler FFT is often denoted a range-Doppler map or R-D map for short. A range-Doppler map is a matrix of complex values, where each column index corresponds to backscatter energy received at a given radar antenna from reflections at a given range, and where each row index corresponds to radar backscatter energy received at a given radar antenna from reflections at a given radial velocity relative to the position of the radar transceiver. A good overview of rudimentary FMCW radar processing is given in the lecture notes “Introduction to mmwave Sensing: FMCW Radars” by Sandeep Rao, Texas Instruments, 2017. The Doppler frequency at the range corresponding to the distance between the radar transceiver and ground is indicative of the radial speed at which the ground moves relative to the radar transceiver, as explained in US 2004/0138802.

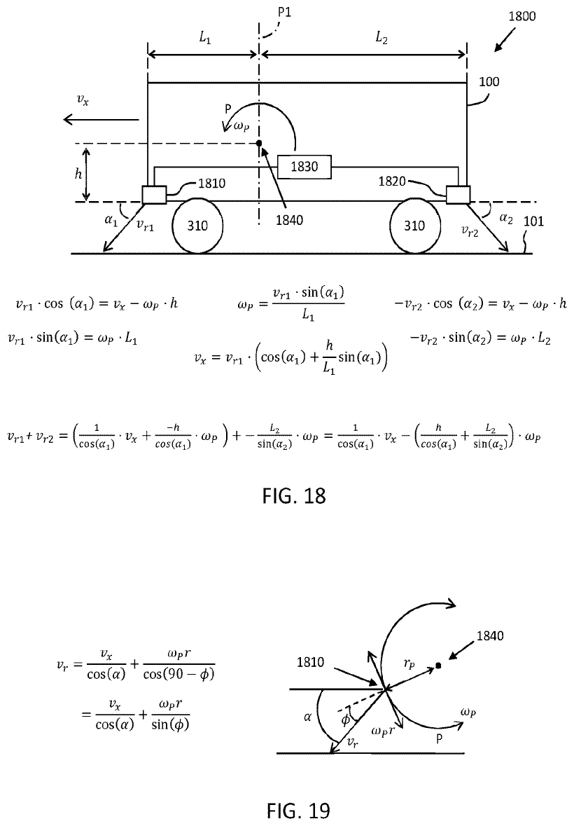

Ground radar systems for determining vehicle motion state have been proposed previously. US 2004/0138802 for instance, discloses a ground radar system for estimating vehicle motion state. The present disclosure builds on this disclosure and other related disclosures and presents several improvements and additional functional features that can be implemented in a ground radar system for estimating vehicle motion state. In relation to US 2004/0138802, it is appreciated that a pitch motion of the vehicle 100 will have an impact on the radial velocity determined by forward and rearward looking radars, and that a roll motion by the vehicle 100 will impact laterally facing radar transceivers. This is because roll motion and pitch motion by the vehicle will move the radar transceivers closer and further away from the ground, and this relative motion with respect to the road surface 101 will have an effect on the radial velocity determined by the radar transceiver. Significant pitch and roll motions by the vehicle, that may occur during hard braking and steering, will negatively impact accuracy of longitudinal and lateral velocity determined by the type of radar systems discussed herein, unless compensated for. However, in most cases of interest the impact from vehicle pitch and roll motion is not significant. The statements made in US 2004/0138802 regarding the need for more than two radar antenna lobes to determine vehicle longitudinal and lateral velocity are therefore not entirely correct, unless particularly strict requirements on accuracy are placed on the system. It is indeed possible to obtain sufficiently accurate speed over ground measurements using only two antenna lobes directed in a first azimuth direction and in a second azimuth direction different from the first azimuth direction, as practical tests involving the radar systems discussed herein have clearly indicated. Further to this, it is appreciated that additional motion sensors such as IMUs and wheel speed sensors can be used as complement to the radar sensors in order to obtain a robust vehicle speed determination system, despite significant roll and pitch motion by the vehicle. Nevertheless, aspects of the present disclosure relate to ground radar systems that are particularly robust to the effects of pitch and roll motion, and which only use two antenna lobes. These systems will be discussed in more detail below in connection to FIGS. 18-20.

To give an example, suppose that a radial velocity vᵣ is measured using a radar module with a transmission main lobe pointing at an azimuth angle α relative to a longitudinal direction of the vehicle 100. This radial velocity can then be projected onto longitudinal and lateral velocity components to obtain a straight-forward estimate of vehicle two-dimensional velocity as

$${v}_{x} = \pm {v}_{r} cos ( α )$$

$${v}_{y} = \pm {v}_{r} sin ( α )$$

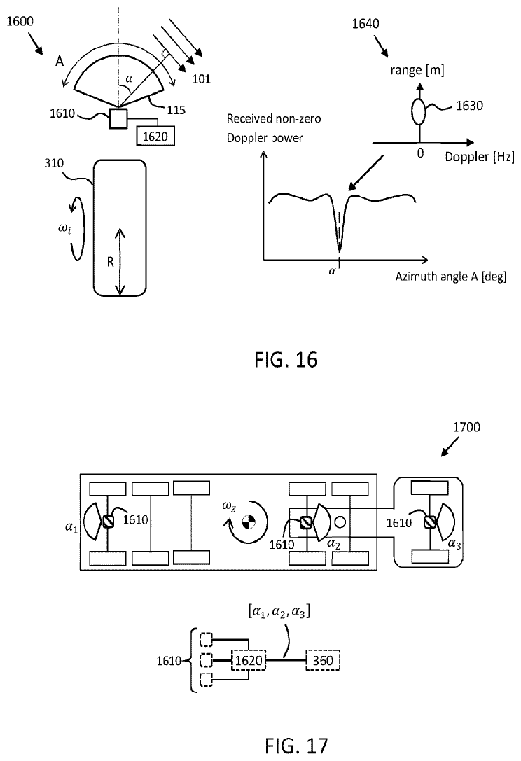

Hence, in fact, only one radar measurement is necessary for a basic two-dimensional speed over ground estimation. It is, however, appreciated that the radar cannot measure velocity perpendicular to the bore-sight direction, as such velocity does not give rise to any radial velocity. This physical effect will be exploited for slip angle estimation below, as will be discussed in connection to FIG. 16 below. The ground radar based vehicle motion state estimator is preferably complemented by at least one more radar transmission beam at azimuth angle β≠α relative to the longitudinal direction of the vehicle 100. This additional radial velocity measurement will pick up velocity components that are orthogonal to the boresight direction of the first measurement, and vice versa, providing an increased availability of the vehicle state estimates from the ground radar system. Practical experimentation using a ground speed radar system of this kind on a heavy-duty vehicle has indeed indicated that this is a feasible approach to determining the speed of a heavy-duty vehicle in many if not all driving scenarios.

U.S. Pat. No. 4,845,506 describes an antenna system suitable for use in ground speed radar systems such as those discussed herein. A switch is implemented that can be used to direct the antenna lobe in either of two fixed directions. The antenna can be used to determine longitudinal velocity of a vehicle if the two directions are aligned with the forward directions of a vehicle, and also lateral velocity of the vehicle if another separate antenna system is mounted on the vehicle with the two directions aligned laterally compared to the forward direction of the vehicle. The antenna system in U.S. Pat. No. 4,845,506 is often referred to as a Janus configuration.

DE 3885397 describes an antenna array that generates two fixed lobes pointing in different azimuth directions. The antenna array is used in a radar system to determine longitudinal velocity of a vehicle. The two directions are fixed directions, and the processing circuitry described in DE 3885397 is not able to exploit more dynamic angle of arrival signal processing to identify suitable received radar signal component for determining a two-dimensional velocity vector of a vehicle.

U.S. Pat. No. 3,363,253 describes a four-beam antenna with fixed direction beams that can be used for ground speed determination. The system is not set up to separate radar signal components received via the same antenna array from each other based on the respective angles of arrival.

EP0095300 describes another vehicle mounted Doppler radar system which comprises a fixed-beam antenna system in Janus configuration. The beams are directed such that the impact of vehicle vibration is minimized.

DE19720846 discloses a system for measuring the speed of a vehicle using a ground speed radar system. The system comprises a fixed beam antenna in Janus configuration.

Several ground radar transceiver systems and functions will be described herein which can be used separately but are preferably used in combination, and that provide improvements to the known ground radar systems for vehicle motion state estimation. An important contribution of this disclosure is also to describe how ground radar systems may be integrated efficiently in advanced VMM system for heavy-duty vehicles, such as the vehicle 100. The combination of a ground radar system that provides accurate speed over ground information and a wheel speed sensor system that gives information indicative of wheel speeds on the vehicle is particularly suitable for a wheel slip based vehicle control strategy, or a wheel speed based vehicle control strategy.

A first improvement of the known ground radar systems that is presented herein is a dual band radar transceiver which integrates a ground penetrating radar transceiver with a high carrier frequency radar transceiver which does not penetrate the road surface. A control unit processes the low frequency band and the high frequency band radar signals jointly in order to determine a ground speed output signal in a reliable manner. According to a preferred example the high carrier frequency radar system uses an antenna array that provides azimuth angular resolution and preferably also elevation angular resolution, while the low carrier frequency radar uses a single antenna lobe transceiver of high output power. This dual band radar system presents an increased robustness compared to ground radar sensor systems that only use a single frequency band of operation.

A second improvement of known ground radar systems presented herein is a notch-based slip angle estimation feature that uses absence of detected radial velocity to determine vehicle slip angle. This ground radar system relies on the capability of measuring angle of arrival of received back-scatter from the road surface and tries to identify an angle of arrival where no radial velocity is detected, or, equivalently, an angle of arrival where most if not all of the radar signal energy is located at zero Doppler frequency. This detected angle can then be used to determine the current slip angle of the vehicle. The principle of minimization of signal energy if often more accurate compared to the principle of maximization of signal energy since the spectral width of a signal energy notch is often narrower compared to the width of a signal energy peak.

A third improvement to the known ground radar systems that is presented herein is a virtual Janus configuration antenna, where outputs from spatially separated radar systems illuminating the road surface in different directions are processed in order to remove the effect of a pitch motion. The principle can be used to cancel out the effects of a pitch motion and/or of a roll motion when estimating speed over ground. The radar systems implementing this feature become less sensitive to roll and pitch motion by the vehicle due to unevenness in the road surface and during maneuvers such as hard braking and turning, and also less sensitive to vibration. This improvement builds on the different Janus configuration antenna disclosures discussed above.

A fourth improvement to the known ground radar systems discussed above uses the principles of the third improvement to estimate the actual location of a pitch axis and/or a roll axis of the vehicle, often referred to as the pitch center and the roll center of the vehicle. This information is important in order to maintain an accurate model of vehicle dynamics and can also be used to detect when an unexpected change in vehicle dynamic properties has occurred, such as a shift in vehicle cargo. The center of gravity height can also be determined, which is an advantage.

FIG. 3 schematically illustrates functionality 300 for controlling an example wheel 310 on the vehicle 100 by some example MSDs here comprising a friction brake 320 (such as a disc brake or a drum brake), a propulsion device 340 and a power steering arrangement 330. The friction brake 320 and the propulsion device are examples of wheel torque generating devices, which can be controlled by one or more motion support device control units 330. The control is based on, e.g., measurement data obtained from a wheel speed sensor 350 and from other vehicle state sensors, such as radar sensors, lidar sensors, and also vision based sensors such as camera sensors and infra-red detectors. An MSD control system 330 may be arranged to control one or more actuators. For instance, it is common that an MSD control system 330 is arranged to control both wheels on an axle.

The TSM function 370 plans driving operation with a time horizon of 10 seconds or so. This time frame corresponds to, e.g., the time it takes for the vehicle 100 to negotiate a curve or the like. The vehicle maneuvers, planned and executed by the TSM function, can be associated with acceleration profiles and curvature profiles which describe a desired target vehicle velocity in the vehicle forward direction and turning to be maintained for a given maneuver. The TSM function continuously requests the desired acceleration profiles a_{req} and steering angles (or curvature profiles c_{req}) from the VMM system 360 which performs force allocation to meet the requests from the TSM function in a safe and robust manner. The VMM system 360 operates on a timescale of below one second or so and will be discussed in more detail below.

The wheel 310, which can be any of the wheels 102 on the vehicle 100, has a longitudinal velocity component vₓ and a lateral velocity component v_{y} (in the coordinate system of the wheel or in the coordinate system of the vehicle, depending on implementation). There is a longitudinal wheel force Fₓ and a lateral wheel force F_{y}, and also a normal force F_{z} acting on the wheel (not shown in FIG. 3). Unless explicitly stated otherwise, the wheel forces are defined in the coordinate system of the wheel, i.e., the longitudinal force is directed in the rolling plane of the wheel, while the lateral wheel force is directed normal to the rolling plane of the wheel. The i-th wheel on the vehicle 100 has a rotational velocity denoted by ωᵢ, and a radius R. The radius if preferably an effective rolling radius of the wheel 310, but an approximation of the effective rolling radius can also be used.

A vehicle speed sensor 380 based on the herein disclosed radar systems is used to determine vehicle speed over ground, which can then be translated into wheel speed components vₓ and/or v_{y} and/or v_{z}, and/or a slip angle α in the coordinate system of the wheel. This means that the wheel steering angle δ is considered if the wheel is a steered wheel, while a non-steered wheel has a longitudinal velocity component which is the same as the vehicle unit to which the wheel is attached.

The type of inverse tyre models exemplified by the graph 200 in FIG. 2 can be used by the VMM 360 to generate a desired tyre force at some wheel. Instead of requesting a torque corresponding to the desired tyre force, the VMM can translate the desired tyre force into an equivalent wheel slip (or, equivalently, a wheel speed relative to a speed over ground) and request this slip instead. The main advantage being that the MSD control device 330 will be able to deliver the requested torque with much higher bandwidth by maintaining operation at the desired wheel slip, using the vehicle speed vₓ from the vehicle speed sensor 380 and the wheel rotational velocity ωᵢ, obtained from the wheel speed sensor 350.

The control unit or units can be arranged to store one or more pre-determined inverse tyre models in memory, e.g., as look-up tables or parameterized functions. An inverse tyre model can also be arranged to be stored in the memory as a function of the current operating condition of the wheel 310.

Particular advantages can be obtained if the radar systems discussed herein are integrated into a wheel end module, i.e., a highly integrated device mounted close to a wheel of the heavy-duty vehicle. A plurality of such wheel end modules can then be used to provide efficient vehicle motion management of a heavy-duty vehicle, as illustrated in FIG. 4. The wheel end module may also comprise other sensors, such as an IMU and a wheel speed sensor, making the wheel end module capable of obtaining accurate and complete information about the operation of the associated wheel. This array of ground radar sensor modules integrated in respective wheel end modules provides an efficient and reliable way to determine vehicle motion state. By central processing of the output data from the different radar modules 110, an accurate vehicle motion state can be determined, including yaw motion ω_{z} and other state variables.

FIG. 5 illustrates an example vehicle control function architecture applicable with the herein disclosed methods, which makes use of the ground radar system. The TSM function 370 generates vehicle motion requests 375, which may comprise a desired steering angle δ or an equivalent curvature c_{req} to be followed by the vehicle, and which may also comprise desired vehicle unit accelerations a_{req} and also other types of vehicle motion requests, which together describe a desired motion by the vehicle along a desired path at a desired velocity profile. It is understood that the motion requests can be used as base for determining or predicting a required amount of longitudinal and lateral forces which needs to be generated in order to successfully complete a maneuver.

The VMM system 360 operates with a time horizon of about 1 second which is a time horizon that is configured based on the control rate requirements of the actuators, and continuously transforms the acceleration profiles a_{req} and curvature profiles c_{req} from the TSM function into control commands for controlling vehicle motion functions, actuated by the different MSDs of the vehicle 100 which report back capabilities to the VMM, which in turn are used as constraints in the vehicle control. Both faster and slower VMM systems 360 are of course possible, i.e., with shorter or longer time horizons. The VMM system 360 performs vehicle state or motion estimation 510, i.e., the VMM system 360 continuously determines a vehicle state s comprising positions, speeds, accelerations, and articulation angles of the different units in the vehicle combination by monitoring operations using various sensors 550 arranged on the vehicle 100, often but not always in connection to the MSDs. An important input to the motion estimation 510 may of course be the signals from the ground radar based vehicle speed sensor system 380 and the wheel speed sensor system 350 on the heavy duty vehicle 100.

The result of the motion estimation 510, i.e., the estimated vehicle state s, is input to a force generation module 520 which determines the required global forces V=[V₁, V₂] for the different vehicle units to cause the vehicle 100 to move according to the requested acceleration and curvature profiles a_{req}, c_{req}, and to behave according to the desired vehicle behavior. The required global force vector V is input to an MSD coordination function 530 which allocates wheel forces and coordinates other MSDs such as steering and suspension. Note that there are several alternative names for global force. Other alternatives names are fictive forces or generalized forces. The MSD coordination function outputs an MSD control allocation for the i:th wheel, which may comprise any of a torque Tᵢ, a longitudinal wheel slip λᵢ, a wheel rotational speed ωᵢ, and/or a wheel steering angle δᵢ. The coordinated MSDs then together provide the desired lateral F_{y} and longitudinal Fₓ forces on the vehicle units, as well as the required moments M_{z}, to obtain the desired motion by the vehicle combination 100.

The MSD control units may obtain wheel speed from one or more wheel speed sensors 350, and also a reliable vehicle speed over ground 380 from the ground speed radar arrangements discussed herein.

Thus, according to some aspects of the present disclosure, the VMM system 360 manages both force generation and MSD coordination, i.e., it determines what forces that are required at the vehicle units in order to fulfil the requests from the TSM function 370, for instance to accelerate the vehicle according to a requested acceleration profile requested by TSM and/or to generate a certain curvature motion by the vehicle also requested by TSM. The forces may comprise e.g., yaw moments M_{z}, longitudinal forces Fₓ and lateral forces F_{y}, as well as different types of torques to be applied at different wheels, and possibly coupling forces between units. The forces are determined such as to generate the vehicle behavior which is expected by the TSM function in response to the control inputs generated by the TSM function 370.

The interface 365 between VMM function 360 and MSD control functions 330 may comprise various requests and status messages, as illustrated in FIG. 5. The VMM function 360 sends requests for actuation according to the result of the performed MSD coordination 530 and receives messages such as status signals and acknowledgement messages back from the MSD control unit or units 330.

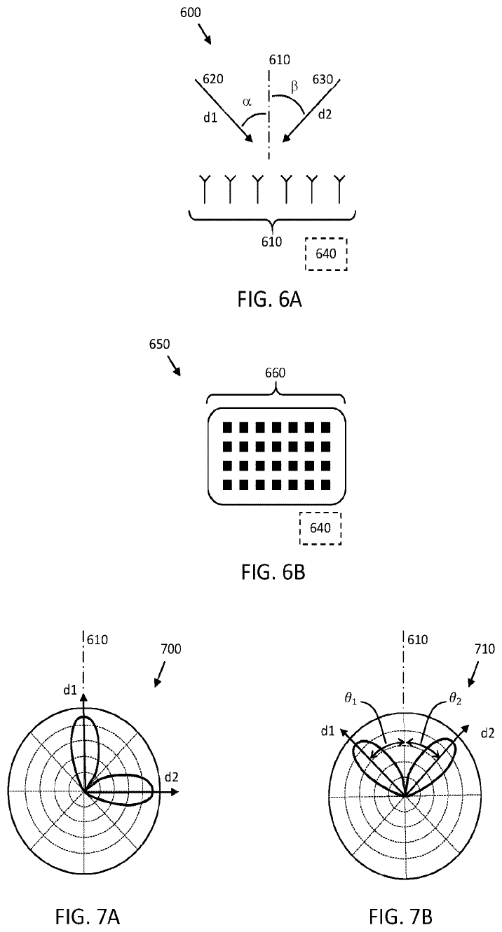

FIGS. 6A and 6B illustrate two example antenna arrays 600, 650 applicable in an example ground speed radar transceiver 110. An antenna array is generally a device comprising a plurality of antenna elements arranged to transmit and/or to receive a radar signal 115. Each pair of transmit antenna and receive antenna in the array gives rise to a respective range-Doppler map, indicating received radar signal energy at different combinations of distances and radial velocities. Each range-Doppler map cell is a complex value associated with a phase and a magnitude, in a known manner. A complex-valued vector of signal values corresponding to a given range and Doppler can be obtained by extracting corresponding values from the range-Doppler map of each antenna pair. The array may comprise multiple antenna elements that are spaced uniformly such as on the order of a half-lambda. Alternatively, they may be spaced more than half lambda. Some previously known radar systems use multiple transmission antennas either sequentially or simultaneously in time to create a virtual aperture sometimes referred to as a Synthetic Aperture Radar (SAR), that is larger than the physical array. The net effect is a relatively small number of real or virtual antenna elements and a relatively small physical aperture. The angle of arrival of an incoming radar reflection can be determined conveniently by a third FFT—the angle FFT, applied to range-Doppler cells from each range-Doppler map generated by each transmit-antenna pair in the radar sensor array, after appropriate zero-padding. The determination of target angle using an FFT may for instance be realized using the Bartlett algorithm. The Bartlett algorithm is generally known and will therefore not be discussed in more detail herein. In case the antenna element spacing is non-uniform, a zero-padding of the complex-valued vector may be needed prior to the FFT operation. Using this technique for angle of arrival processing, the processing device of the radar module can analyze a received radar signal in terms of angle of arrival and detect first and second radar signal components of the received radar signal based on their respective angle of arrival. Thus, it does not matter in which direction the radar signal was transmitted, or if the radar signal was transmitted in a wide lobe or in one or more narrow lobes, since the processing device will identify radar signal components based on their angles of arrival, and from there determine the two-dimensional velocity vector [vₓ, v_{y}] of the heavy-duty vehicle based on respective Doppler frequencies of the first and of the second detected radar signal component. The antenna array 600 in FIG. 6A comprises a plurality of antenna elements 610 arranged on a line and is therefore able to both emit and receive signals from different directions such as the illustrated example directions d1, d2 in a plane, essentially forming antenna lobes in the different directions (at least for receiving backscattered radar signal). The antenna array 600 has a bore sight direction 610 that can serve as reference for the azimuth angles. In the example of FIG. 6A, a first signal component 620 is received from azimuth angle α and a second signal component 630 is received from azimuth angle β.

FIGS. 7A and 7B show example antenna diagrams 700,710 of how antenna gain (after array signal processing), may vary over azimuth angle. These particular example antenna arrays have been configured to emit radar energy in a first azimuth direction d1 which in the first example coincides with a longitudinal direction of the vehicle 100, and in a second azimuth direction d2 which coincides with a lateral direction of the vehicle. Thus, radial motion in the first azimuth direction is indicative of longitudinal velocity of the vehicle while radial motion in the second azimuth direction is indicative of vehicle velocity in the lateral direction of the vehicle. In the example 710 the two antenna lobes are instead directed at about 45 degrees to each side of the bore sight direction 610.

The processing device 640 is, according to some aspects, arranged to adjust a setting of the antenna array 600, 650 based on a desired antenna diagram of the radar transceiver 110. This means that the processing device 640 may calibrate the settings of the antenna array, i.e., the beamforming weights of the antenna array or its phase settings, in order to point the antenna lobes in the desired directions, such as the longitudinal and lateral directions of the vehicle 100. For example, the vehicle can be controlled to travel without sideslip in the longitudinal direction during a calibration drive operation, and the processing device can then optimize the setting of the antenna array to maximize the radar signal power and the Doppler frequency in the first azimuth direction, and to maximize the radar signal power but minimize the Doppler frequency in the second azimuth direction. This essentially means that the processing device performs a beam steering operation involving the antenna array in order to focus antenna beams in one or more desired directions. The antenna beams can also be directed at either side of a bore sight direction of the antenna array, in order to enable differential detection of lateral vehicle motion, i.e., as in the example 710. In this case the processing device 640 will during antenna array calibration perform beam steering to make the Doppler frequencies of the two radar signal components as equal as possible when the vehicle is driving in the longitudinal direction without significant sideslip or lateral motion.

The antenna array 650 schematically illustrated in FIG. 6B comprises a plurality of antenna elements 660 arranged on a two-dimensional grid (seen from in front of the array). Radar signal energy emitted via this antenna array can be steered in both azimuth and elevation dimensions, allowing the antenna array to focus radar signal energy with additional degrees of freedom compared to the array 600 in FIG. 6A. Antenna lobes can also be focused or made broader by configuration of the antenna array, using known beamforming techniques. Other antenna geometries are of course known. The antenna array geometries in FIG. 6A and in FIG. 6B are mere examples. The teachings herein can be used with most if not all prior art antenna geometries.

At least some of the radar transceiver systems discussed herein are arranged to adapt the shape of the antenna lobe to the operating conditions of the vehicle 100. For instance, in case the road surface 101 is uneven, then it may be beneficial to increase the size of the illuminated patch of road 130a-e, while a smaller size of the illuminated patch of road 130a-e can be advantageous in case of a more even road. An IMU and/or a map indicating road type in combination with a global positioning system receiver can be used to determine the evenness of the road surface 101. The ground radar system can also be used to determine the evenness of the road surface 101, e.g., by monitoring a variation in detected range, which will vary more over time if the road surface is uneven compared to if the road surface is more even. A LUT can be used to adjust the antenna diagram, in dependence of the vehicle operating condition. The variation in measured vehicle velocity by the one or more ground radar transceivers 110 can also be used to adjust the width of the antenna lobe in operation, where a target root-mean-square (RMS) value or the like can be used to adapt the width of the lobe until a desired RMS value of the measured vehicle speed is obtained. It is noted that some antenna arrays may be arranged to adjust the shape of the antenna lobe in two dimensions, such that the longitudinal width of the illuminated patch of road 130a-e is adjusted separately from the lateral width of the illuminated patch of road 130a-e. The longitudinal width and the lateral widths can then be adjusted based on an RMS value of the measured longitudinal and lateral velocities of the vehicle 100 (at the location of the radar transceiver). It is interesting to note that an adjustment in the lobe longitudinal width will increase the spatial averaging performed in the longitudinal direction while an increase of the antenna lobe width in the lateral direction will increase the amount of spatial averaging in the lateral direction. Thus, by adjusting widths in longitudinal and lateral directions the amount of averaging performed in each “dimension” can be optimized to the current operating conditions of the vehicle. It may, e.g., be desired to have more averaging in the lateral direction in order to detect smaller lateral velocities compared to in the longitudinal direction where speeds are often much higher.

If the two directions d1 and d2 are pointing in some other azimuth direction compared to the vehicle longitudinal and lateral directions, e.g., as illustrated in FIG. 7B, then a transform may be required in order to obtain the vehicle speed in longitudinal and lateral directions. In the example of FIG. 7B, this transform may be selected as

$${v}_{x} = {ν}_{d 1} cos ( {θ}_{1} )$$

$${v}_{y} = {ν}_{d 1} sin ( {θ}_{1} )$$

where v_{d1} is the radial velocity measured on the radar signal from direction d1. In the same manner

$${v}_{x} = {v}_{d 2} cos ( {θ}_{2} )$$

$${v}_{y} = {v}_{d 2} sin ( {θ}_{2} )$$

where v_{d2} is the radial velocity measured on the radar signal from direction d2. A similar transform can be used for the radar signal inbound from direction d2.

The ground speed radar transceivers 110 discussed herein illuminate one or more portions of the road surface under the vehicle or in vicinity of the vehicle, and preferably close to a respective wheel as discussed above. The illuminated portions are either smaller portions 130a, 130b, 130c or larger portions 130d, 130e as illustrated in FIG. 1. Portions of adaptable size are also possible as discussed above. Some of the radar transceivers 110 discussed herein receive backscattered energy from the road surface from at least two different azimuth directions. The use of an antenna array allows the processing device to perform angle of arrival signal processing to separate backscattered radar signal energy which arrives from different directions, thereby allowing the radar module to identify two or more radar signal components arriving from different azimuth directions using a single antenna array and possibly also a single transmit antenna. The radial velocity of the road surface in the two different directions will be indicative of the velocity of the vehicle in two dimensions, or even in three dimensions in case a more advanced antenna array is used, such as a two-dimensional antenna array. For instance, if the first azimuth direction is a longitudinal direction of the vehicle 100 and the second azimuth direction is a lateral direction of the vehicle 100, then the Doppler information of the first and the second radar signal components will be directly indicative of the vehicle longitudinal and lateral speeds. The radar transceiver can also be mounted together with a steered wheel and turn the antenna diagram as the wheel is steered, which means that the velocity components will be determined in the coordinate system of the wheel without need for mathematical transforms from a vehicle coordinate system into the coordinate system of the wheel. This is an advantage if the ground speed sensor is a stand-alone vehicle state sensor that is to be used separately from a VMM system of the vehicle 100, e.g., if the vehicle is a legacy vehicle lacking advanced functions for vehicle state estimation.

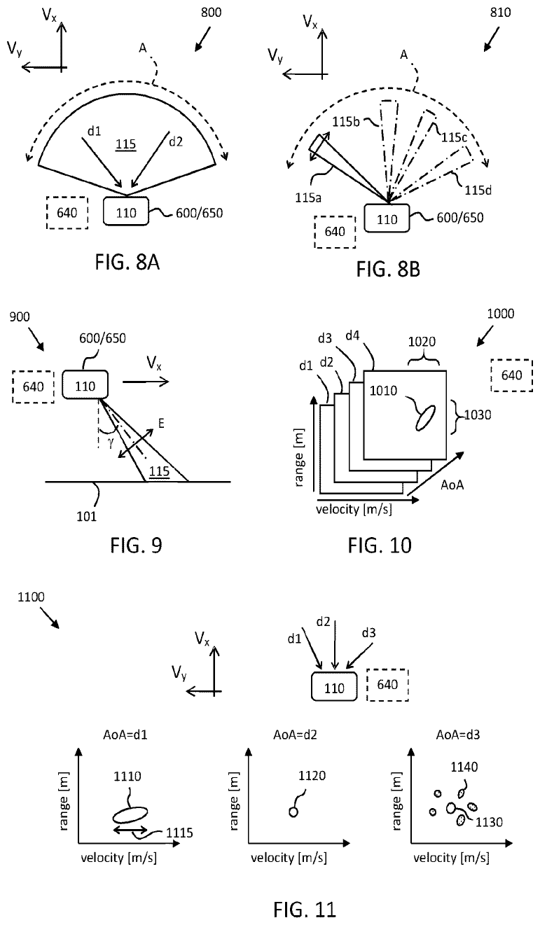

An antenna array 600, 650 comprised in a radar module 110 can be configured to emit the radar signal 115 in a first azimuth direction d1 and in a second azimuth direction d2 different from the first azimuth direction. This means that the radar signal illuminates the road surface 101 in at least two directions. This can be done by illuminating a larger area of the road surface by a relatively broad antenna beam as illustrated in FIG. 8A, or by illuminating two or more separate sections of the road surface 101 by a plurality of more narrow beams, or by a beam arranged to be swept over a range of different azimuth angles, as illustrated in FIG. 8B. An example radar system according to aspects of the present disclosure can be mounted to the vehicle chassis, as shown in FIG. 1, such that both the first azimuth direction and the second azimuth direction points towards the ground, but in different azimuth directions. Since the radar illuminates the ground in at least two different azimuth directions, it is able to receive backscattered radar signals from two or more different azimuth directions. This can be exploited by array signal processing at the radar system in order to determine vehicle velocity in more than one dimension, i.e., in longitudinal and lateral directions, relative to the vehicle or relative to a wheel on the vehicle, including both steered and non-steered wheels, using a single radar transceiver instead of two or more radar transceivers as proposed in US 2004/0138802.

With reference to FIG. 8A, the antenna array 600, 650 of the radar module 110 can be configured to emit the radar signal 115 over a range A of different azimuth directions which comprises at least the first azimuth direction d1 and the second azimuth direction d2. A portion of the road surface 101 in vicinity of the radar module 110 is thus illuminated by radar signal energy, and a part of this radar signal energy is reflected back towards the antenna array. The processing device 640 can be arranged to evaluate received radar signal power over the range A of azimuth directions using the type of angle of arrival array signal processing discussed above, e.g., by computing angle FFTs. The processing device 640 receives radar signal data indicative of the received radar signal from the antenna array 600, 650 and investigates if radar signal has been received from the different azimuth directions. If a radar signal component is detected for a given angle or arrival, then its respective Doppler frequency is determined, e.g., from the range-Doppler map corresponding to the azimuth direction where the radar signal component was detected. Some azimuth directions may have strong and distinct received radar signal components from which a reliable radial velocity of the vehicle can be determined, while other azimuth angles may only have diffuse received radar signal power or interference appearing as clutter in the corresponding range-Doppler map. One angle of arrival may also have no Doppler signal energy at all, this can be exploited for determination of slip angle, as will be discussed in more detail below in connection to FIG. 16. The different detected Doppler frequencies over the range A of azimuth directions can be weighted together, based, e.g., on received signal strength, in order to form a more reliable estimate of vehicle speed over ground.

A set of discrete azimuth directions may also constitute the range A of azimuth directions, i.e., the processing device 640 can be arranged to evaluate the received radar signal power in a number of discrete azimuth directions which cover the range A of azimuth directions. This option is preferred if angle-FFTs are determined by the processing device. Alternatively, the range A of azimuth directions can be configured as a continuous range of azimuth directions, in which case the processing device 640 may be configured to steer a receive lobe of the antenna array to investigate from which angles of arrival that useful radar signal energy is received, that can be used to determine the two-dimensional velocity vector [vₓ, v_{y}] of the heavy-duty vehicle 100 based on the Doppler frequencies of the radar signal components. Steered receive lobe beamforming can be used to optimize received signal power by adjusting the direction of the receive lobe to maximize received signal power. The different detected Doppler frequencies over the range A of azimuth directions can be weighted together also in case a set of discrete directions are used by the radar transceiver, based, e.g., on received signal strength, in order to form a more reliable estimate of vehicle speed over ground. In both cases the antenna array of the radar module 110 is used to monitor incoming radar signal energy from different azimuth directions, and optionally also from different elevation directions, detect radar signal components that can be used for ground speed determination, and determine the two-dimensional velocity vector of the heavy-duty vehicle 100 based on the detected radar signal components.

The actual azimuth direction of arrival of a radar signal component corresponding to a given antenna array beam steering configuration may be obtained from calibration of the radar system. Both on-line and off-line calibration can be used. An off-line calibration may, e.g., comprise a look-up table where beam steering vectors can be translated into azimuth angle of arrival. On-line calibration may comprise detecting that the vehicle is moving in a straight line (no applied steering), with little or no applied wheel force, in which case the vehicle speed over ground should only comprise longitudinal speed and no lateral speed. Hence, a detected radial velocity can be related to a vehicle speed over ground direction. Wheel speeds can be used to calibrate radial velocity magnitude. Calibration of radar systems such as the ones discussed herein are generally known and will therefore not be discussed in more detail herein.

An antenna array 600, 650 can be configured to emit the radar signal 115 in a transmission lobe simultaneously covering the range A of azimuth directions, as illustrated by the example 800 in FIG. 8A, or in one or more transmission lobes that are narrower than the range A of azimuth directions, as illustrated by the example 810 in FIG. 8B. The narrow transmission lobe can be swept over the range A as illustrated by transmission lobe 115a (illustrated by solid line) or emitted as a plurality of separate narrow beams 115b, 115c, 115d (illustrated by dash-dotted lines) which at least partly covers the range A of azimuth directions. The separate narrow beams 115b, 115c, 115d may be partly overlapping, or separated from each other. There may be gaps in-between the narrow beams 115b, 115c, 115d as in the example 810.

FIG. 9 illustrates another example radar operation 900 where the antenna array 600, 650 is configured to emit the radar signal 115 in a transmission lobe that covers a range E of different elevation directions y. The processing device 640 can then apply array processing of the received radar signal to also detect radar signal energy incoming from different elevation directions. This is an advantage since more distinct radar signal components may be detected by considering different elevation angles separately. The elevation angle of transmission and/or reception of radar signal energy can also be optimized by varying the elevation angle of the transmission and/or of the reception, e.g., to maximize received radar signal power, in the same manner as the adjustment of transmission lobe width discussed above. Some road surfaces are less prone to reflecting radar signal energy compared to other road surfaces. A rough road surface generally reflects radar signal energy batter than a very smooth road surface, such as a road surface with standing water. The better the road surface reflects radar signal energy, the less steep the elevation angle can be. I.e., in case the road surface reflects radar signal energy poorly the angle γ in FIG. 9 can be decreased, directing the radar signal more directly towards the road surface, and vice versa. Adaptation of antenna lobe elevation angle can advantageously be combined with adaptation of the antenna lobe width as discussed above. The different detected Doppler frequencies over the range E of different elevation directions y can be weighted together, based, e.g., on received signal strength, in order to form a more reliable estimate of vehicle speed over ground.

The ground radar system can be configured to perform a test or calibration routine where a number of different antenna lobe widths and elevation angles are tested in sequence in order to determine a suitable antenna lobe configuration for a given vehicle operating condition. The metric evaluated during the test routine may be, e.g., an RMS value of one or more measured values, such as longitudinal and lateral speed, or slip angle, or distance to ground. The metric may also comprise a difference between measured speed over ground and a wheel speed signal for a free-rolling wheel.

FIG. 10 illustrates an example 1000 of angle of arrival signal processing by the processing device 640. The processing device 640, using an antenna array such as the antenna arrays 600, 650 in FIG. 6A and FIG. 6B, evaluates radar signal power received from a number of different azimuth directions d1, d2, d3, d4 and computes a range-Doppler map for each angle of arrival. Any received radar signal components 1010 are detected using some form of acceptance criterion. One example acceptance criterion is a straightforward threshold applied to received signal energy. However, more advanced detection criteria can also be applied, such as a criterion which requires that a majority of signal energy is concentrated in a predetermined Doppler interval 1020, such that the radar signal component is not overly spread out. An acceptance criterion may also comprise a requirement that the radar signal energy is located in a predetermined range interval 1030 corresponding to a nominal range from the radar transceiver to the road surface 101. This way false reflections can be discarded.

An advantage of using this type of receive array processing wherein received radar signal components coming from different azimuth directions are detected is that the transmission direction of the radar signal energy that illuminates the road surface 101 does not need to be coordinated with the receive direction of the receiver. Hence, the antenna array 600, 650 may comprises a transmit portion and a receive portion arranged spatially separated from the transmit portion, operating independently from each other. A transmit portion of the antenna array may be arranged at one location on the vehicle 100, and one or more receive portions of the antenna array can be arranged at other locations where they receive a part of the transmitted and reflected radar signal energy. The angle of arrival of the different radar signal components received by the receive portions can then be used to determine the two-dimensional velocity vector of the heavy-duty vehicle. It may be an advantage to use less transmitters than receivers since a single ground radar transmitter can then be shared by more than one ground radar receiver.

According to some aspects, the processing device 640 is arranged to determine respective accuracy metrics for the first and second radar signal components 620, 630, based on a spread of received radar signal power over Doppler frequency and/or over range. FIG. 11 illustrates an example 1100 of how the radar signal components may appear in the range-Doppler maps for different azimuth directions d1, d2, d3. The first radar signal component 1110 detected in azimuth direction d1 is relatively spread out in the Doppler dimension 1115, meaning that an exact determination of radial velocity is difficult to achieve based solely on this radar signal component. The range of this signal component is more focused and therefore probably the range estimate is better. An accuracy metric determined for this radar signal component with respect to velocity will be lower than average due to the diffuse nature of the radar signal component energy over the range-Doppler map velocity dimension. An example accuracy metric M₁ indicating this type of “diffuseness” may, e.g., be formulated as

$${M}_{1} = \frac{1}{n} {\sum }_{i = 1}^{n} {( {D}_{i} - \overline{D} )}^{2}$$

where n is a number of Doppler samples related to the radar signal component, Dᵢ is the Doppler frequency of the i-th sample, and D is the mean of the Doppler samples. The n samples may, e.g., be selected as FFT bins having signal power above a threshold.

The second radar signal component 1120 is much more distinct compared to the first radar signal component 1110. This radar signal component, associated with azimuth direction d2, will be assigned a higher accuracy metric compared to the first radar signal component d1. The third radar signal component arriving from azimuth direction d3 is distinct, but there is also a lot of clutter 1140 which complicates the determination of the two-dimensional velocity vector of the heavy-duty vehicle 100 based on the Doppler frequency of the radar signal component 1130. An example accuracy metric M₂ indicating amount of interference may, e.g., be formulated as a peak radar signal component power compared to an average received signal power over the range-Doppler map, or as an accumulated signal power of a detected received radar signal component compared to an average signal power in the range-Doppler map. A number of separate radar signal detections in a range-Doppler map can also be used as indication of amount of interference, since there should only be one strong radar signal component per angle of arrival.

In some cases, the antenna lobe illuminates a larger portion of the road surface, which means that backscatter will be detected for a plurality of ranges, where each range has its respective Doppler frequency or radial velocity. In case the road surface is illuminated by a radar transceiver 110 over a range of elevation angles γ for instance (as illustrated in FIG. 9) and if the radar transceiver is pointing longitudinally, then a plurality of increasing velocity components will be observed for a respective plurality of increasing ranges. These velocity components are useful velocity components that can be weighted together in order to obtain a more reliable estimate of longitudinal and/or lateral velocity relative to the ground surface. In case the Doppler spreads out for one or more ranges, then those velocity samples can be down-weighted in the estimation of speed over ground.

The accuracy metric may be determined in a number of different ways, e.g., as a measure of radar signal energy spread from the centroid of the radar signal component in the range-Doppler map, as a measure of variance of the radar signal component over the range-Doppler map, as a measure of the total radar signal energy of the radar signal component, and also as a measure of the peak power of the radar signal component.

The processing device 640 can also be arranged to control transmission of the radar signal in dependence of the determined accuracy metrics. For instance, in case particularly good reflections are received from a given azimuth direction, then the processing device 640 may be arranged to control transmission such that radar signal energy becomes more focused in those good directions, and less focused in directions where worse reflections is obtained. A “good” reflection may be determined based on one or more of the accuracy metrics discussed above. The processing device may be configured to sweep a transmission lobe 115a over the range A of azimuth directions, and/or over the range E of different elevation directions and select a sub-range or a discrete number of directions where the transmission lobe may dwell. The sweep can be repeated regularly, such as every 500 ms to determine if better transmission directions have appeared.

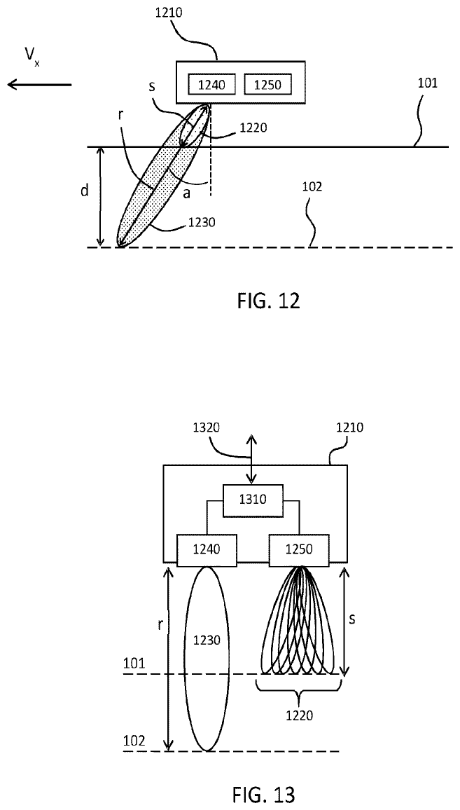

FIG. 12 illustrates a dual band ground-penetrating radar transceiver 1210 which can be used to determine vehicle speed over ground regardless of the surface conditions, i.e., regardless of whether the road surface is smooth or scattering radar signals, and regardless of whether there is reflective matter on the road surface which moves relative to the road surface, such as running water. The reason is that the dual band ground-penetrating radar transceiver 1210 has at least one transmission lobe 1230 that penetrates the road surface 101, i.e., that extends beyond the road surface 101 at least down to a plane 102 located a distance d below the road surface 101. Thus, there are radar reflections generated also from points below the actual road surface, such as in the plane 102 which lies a distance d below the road surface 101. In the example of FIG. 12, the transmission lobe intersects the plane 102 at range r, while the road surface 101 is at a distance s (smaller than r) from the antenna of the radar transceiver 1210 along the direction of the ground penetrating radar transmission lobe. The reflections from this point below the surface can normally be guaranteed to be stable and to provide a good foundation for establishing the vehicle speed over ground, regardless of any moving matter at the road surface 101, which is an advantage.

According to some aspects, the plane 102 is a road foundation layer which is associated with relatively strong scattering. The actual distance r at which the speed over ground is determined is not so important, as long as it is below the surface 101, away from the matter which may be moving there and cause errors in the determination of the speed over ground.

The radar transceiver 1210 is advantageously configured with a boresight direction of a transmission lobe in the longitudinal direction of the vehicle that intersects the road surface 101 at an angle a, as shown in FIG. 12. This angle a may vary from implementation to implementation, but a value between 30-70 degrees has been found to give satisfactory results, and preferably about 45 degrees. It is noted that the radar transceiver 1210 will detect relative velocity in its radial direction only, and not see the tangential component of the relative velocity between radar transceiver and a detected target.

The radar transceiver 1210 is preferably but not necessarily configured with a transmission lobe azimuth angular width below ten degrees, and preferably below five degrees, i.e., a relatively narrow beam. This narrow beam decreases the number of strong reflections received from the ambient environment and from the vehicle itself, and therefore simplifies detecting the Doppler frequency associated with the point under the road surface 101. It is also easier to achieve a high power radar signal in this type of relatively narrow transmission lobe, which penetrates the road surface better compared to a smaller gain radar signal. As for the radar transceivers discussed above, the ground penetrating radar may also be associated with a lobe that has, e.g., an angular spread y in the elevation direction. This angular spread will give rise to more received Doppler frequencies. A centroid of the detected Doppler frequencies for each range can, e.g., be used to determine the speed over ground by the vehicle.

A ground penetrating radar may be used with advantage on its own but is preferably complemented by a higher frequency radar transceiver that does not penetrate the road surface, such as an E-band radar. The higher carrier frequency system can then use a larger frequency bandwidth since more frequency bandwidth is normally available at higher carrier frequencies. Also, due to the higher carrier frequency, the wavelength of the transmitted radar signal is also smaller, which means that reasonably sized antenna arrays can be implemented, such as the antenna arrays 600, 650 discussed above in connection to FIGS. 6A and 6B. This way the techniques discussed in connection to FIGS. 8A-B, 9 and 10 can be implemented by the high carrier frequency radar transceiver.

FIG. 12 and FIG. 13 illustrate example dual band radar transceiver systems 1210 configured to determine a velocity (vₓ and/or v_{y} and/or v_{z}) of the heavy-duty vehicle 100 with respect to the road surface 101 supporting the vehicle 100. The transceiver system comprises a first radar transceiver 1240, a second radar transceiver 1250, and processing circuitry 1310 (not shown in FIG. 12), where the first radar transceiver 1240 is arranged to operate at a first carrier frequency f1, and where the second radar transceiver 1250 is arranged to operate at a second carrier frequency f2 higher than the first carrier frequency f1. More than two different radar frequency bands can also be used, although two different bands (one high carrier frequency and one low carrier frequency) are normally sufficient. The first radar transceiver 1240 and the second radar transceiver 1250 are preferably integrated in a common housing, but they can also be spatially separated from each other, as long as they share at least some common processing circuitry 1310. This dual-band ground radar system can be used with most if not all other techniques discussed herein.

The second radar transceiver 1250 is in FIG. 13 illustrated as having the capability to generate a plurality of antenna lobes. This is an optional but preferred feature of the second radar transceiver 1250. Any of the antenna array systems and features can be used with any of the first and/or radar transceivers 1240, 1250, although it is appreciated that an antenna array for the low carrier frequency system may become prohibitively large.

The first radar transceiver 1240 is arranged to transmit a radar signal at the first carrier frequency f1, to receive a reflected radar signal at the first carrier frequency f1 from at least one location below the road surface 101, and to detect a first Doppler frequency indicative of the velocity of the heavy-duty vehicle 100 based on the received radar signal at the first carrier frequency f1. The first carrier frequency f1 may, e.g., be between 10 MHz and 10 GHz, while the second carrier frequency f2 is larger than 10 GHz, such as larger than 60 GHz.

The second radar transceiver 1250 is arranged to transmit a radar signal at the second carrier frequency f2, to receive a reflected radar signal at the second carrier frequency f2 from at least one location on the road surface 101, and to detect a second Doppler frequency indicative of the velocity vₓ, v_{y} of the heavy-duty vehicle 100 based on the received radar signal at the second carrier frequency f2. An E-band radar transceiver may suitably be selected as the second radar transceiver 1250. The E band is a frequency range from 60 GHz to 90 GHZ, where the frequency band around 76 GHZ is allowed for unlicensed use, such as for collision avoidance applications in the transportation industry.

The processing circuitry 1310 is arranged to determine the velocity of the heavy-duty vehicle 100 jointly based on the first Doppler frequency and on the second Doppler frequency. The two radar transceivers complement each other and provide a vehicle motion state estimate which is more reliable than the sum of the two, i.e., there are synergy effects in exploiting two different radar frequency bands on this manner. The first radar transceiver can be optimized for penetrating down below the road surface (which requires relatively low carrier frequency operation) where very stable velocity data can be obtained with a minimum of clutter from debris, water spray and moving objects such as the wheels on the vehicle 100 and other vehicles in the vicinity of the vehicle 100. Due to the low carrier frequency, the bandwidth of the first radar transceiver may be limited, which of course reduces the range resolution, and it may also limit the chirp repetition intervals used. The processing circuitry 1310 optionally but preferably implements a common interface 1320 towards other functional modules, such as the VMM function 360 discussed above and/or one or more MSD control units 330. It is an advantage that the dual band radar system has a single interface, where the velocity of the heavy-duty vehicle 100, determined based on both the first and on the second Doppler frequencies, is output.

The output power of the first radar transceiver 1240 is preferably larger than the output power of the second radar transceiver 1250, such that it may penetrate sufficiently deep under the road surface 101. The low carrier frequency also means that the wavelength is relatively large, which in turn means that antenna arrays that allow advanced antenna functions such as lobe shaping, and beam steering may become prohibitively large. However, the second radar transceiver 1250 operates at much higher carrier frequencies where antenna arrays are reasonably sized and where much larger frequency bandwidths of operation are available, i.e., the frequency bandwidth of the second radar transceiver 1250 is preferably larger than the frequency bandwidth of the first radar transceiver 1240. The processing circuitry 1310 can process the two radar signals jointly in order to obtain a reliable and highly accurate estimate of vehicle state, and optionally also output this more reliable estimate of vehicle state on the single common interface 1320. For instance, according to some aspects, the processing circuitry 1310 is arranged to determine the velocity (vₓ and/or v_{y} and/or v_{z}) of the heavy-duty vehicle 100 based on a weighted combination of the first Doppler frequency and the second Doppler frequency, where the weights are selected as fixed predetermined weights or in dependence of the different signal qualities, as discussed above in connection to FIG. 11, where the low carrier frequency radar transceiver output can be seen as just another angle.

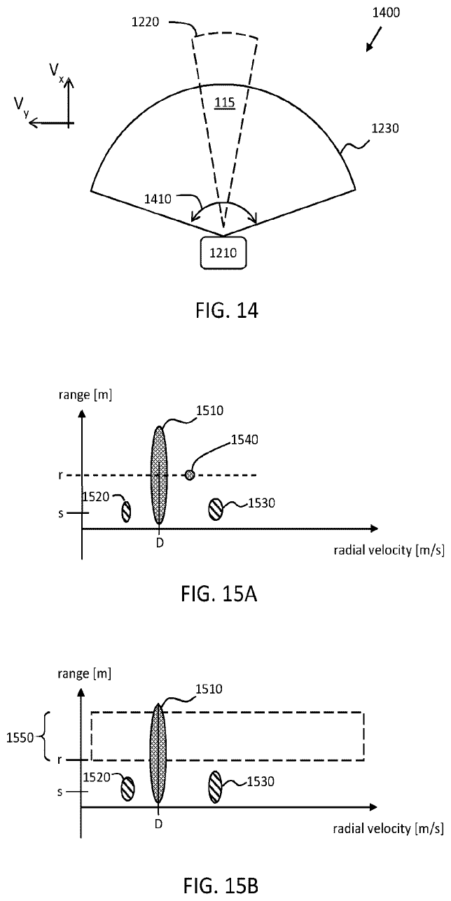

FIG. 14 illustrates a combined radar operation 1400 of the dual band radar transceiver system 1210. The dual band radar transceiver 1210 outputs a first radar signal in a first antenna pattern 1220 by the first radar transceiver 1240 and a second radar signal in a second antenna pattern 1230 by the second radar transceiver 1250. The first antenna pattern 1220 is more narrow compared to the second antenna pattern 1230 at least in azimuth, but the first antenna pattern also has higher gain in this example. The second antenna pattern allows angular resolution of incoming radar signals, which the first antenna pattern does not.

According to some aspects, the second radar transceiver 1250 is arranged to detect an azimuth angle α, β of the received radar signal at the second carrier frequency f2, hence the type of processing discussed above in connection to, e.g., FIGS. 6A-B, 7A-B, 8A-B, 9 and 10 are available for the second radar transceiver 1250. The second radar transceiver 1250 may also be arranged to detect an elevation angle γ of the received radar signal at the second carrier frequency f2. Adjustments of both antenna lobe width and elevation angle in order to optimize performance can also be implemented by the second radar transceiver 1250.

The first radar transceiver 1240 may, according to some aspects, be arranged to determine a one-dimensional velocity while the second radar transceiver 1250 is arranged to determine a two-dimensional velocity vector [vₓ, v_{y}], or even a three-dimensional velocity vector [vₓ, v_{y}, v_{z}]. The one-dimensional velocity determined by the first radar transceiver 1240 may, e.g., be a longitudinal velocity vₓ of the vehicle 100, which is important during hard braking in order to maintain close to optimal wheel slip, as discussed above in connection to FIG. 2. This longitudinal velocity vₓ can be relied upon since it has been determined relative to one or more locations below the road surface, where the back-scattering environment is very stable. The second radar transceiver 1250 on the other hand, can be used for more advanced vehicle motion state measurement, such as measurements of lateral velocity and side slip angles. According to some aspects the vehicle 100 comprises more radar transceivers of the second high carrier frequency type compared to the number of radar transceivers of the first low carrier frequency type. The first radar transceiver 1240 and the second radar transceiver 1250 can also be integrally formed in a single housing. This single housing optionally comprises an IMU and/or a wheel speed sensor. The first radar transceiver 1240 and the second radar transceiver 1250 can also be integrally formed in a wheel end module of the heavy-duty vehicle 100.

The processing circuitry 1310 can also be arranged to validate the determined velocity of the heavy-duty vehicle 100 based on a comparison of the first Doppler frequency and the second Doppler frequency. The two estimates of vehicle velocity are made in different ways and therefore exhibit a degree of independence. In case the two velocities determined by the first radar transceiver and by the second radar transceiver differs too much, i.e., in case a difference between the first Doppler frequency and the second Doppler frequency does not fulfil an acceptance criterion such as a predetermined threshold or some type of preconfigured statistical test, then something may be seriously wrong. In this case the processing circuitry 1310 can, e.g., trigger generation of a notification signal to the VMM function 360 or to some other control function on the vehicle 100.

FIG. 15A schematically illustrates an example range-Doppler map of a received radar signal by the first radar transceiver 1240. Range-Doppler maps are generally known to visualize received radar echoes based on the range to the target and the radial velocity of the target relative to the radar transceiver (determined from the Doppler shift on the received signal relative to the transmitted signal in a known manner). A range-Doppler map allows a receiver to separate radar detections which are at different ranges from the radar transceiver and/or are moving with different radial velocities relative to the radar transceiver. To determine the radial motion velocity of the point 1510 relative to the radar transceiver, a control unit only has to read out the Doppler frequency at the specified range r. Due to the azimuth width and the direction of the main transmission lobe, the reflections from the point 1510 will normally dominate over other weaker reflections, at least if averaged over some short period of time.

FIG. 15A illustrates a common situation where there are several detections 1510, 1520, 1530 at ranges close to the road surface, i.e., around the range s. Hence, it is difficult to know which of the detections that indicate the true vehicle speed over ground. However, all detections 1510 in the transmission lobe at ranges around the range r, corresponding to the point under the road surface, is normally free from clutter. To find the speed over ground, the strongest detection at some range r greater than the range s is first found. The Doppler frequency (or, equivalently, the radial relative velocity D) associated with this detection is then used to determine the speed over ground of the vehicle. If there is more than one Doppler frequency bin with non-negligible detection energy, i.e., more than one radar detection 1510, 1540 at the specified range r, then a weighted sum can be formed to estimate the radial velocity. The weights can be determined based on the energy in each Doppler frequency bin. The strongest detection at the specified range r can also be selected, since it is most likely that the strongest detection corresponds to the desired radial velocity.

The range r at which the Doppler value is determined can advantageously be determined relative to the road surface, say about 10 cm beyond the range to the road surface, i.e., according to some aspects

$$r = s + Δ [ m ]$$

where Δ is the positive offset value added to s to obtain r. This means that the actual range r changes continuously to follow, e.g., motion of the vehicle along a normal vector to the road surface but stays more or less at the same distance relative to the road surface 101. The road surface at distance s is often visible as a strong reflection, although the Doppler content at this range s may comprise more than one component due to clutter as discussed above. Thus, according to some aspects, the radar transceiver may first detect the distance s from the radar transceiver 1210 to the road surface along the pointing direction of the antenna transmission lobe and then determine the distance r to the point of interest below the road surface 101 relative to the road surface distance s, e.g., by adding a predetermined positive offset A to the detected distance s as discussed above. According to other aspects, the radar transceiver 1210 may just determine the distance d below the road surface 101 as a pre-determined distance from the radar transceiver 1210. In this case any suitable distance r may be selected as long as it is larger than the distance s.

To improve accuracy further, the radar transceiver 1210 may be configured to receive data indicative of a vehicle height over ground, or a height over ground of the radar transceiver 1210. This type of data may, e.g., be obtained from a linear position sensor configured in connection to the vehicle suspension, such as a suspension system sensor. Thus, as the vehicle moves up and down along a normal to the road surface, the detected Doppler frequency can be adjusted to account for the motion, which improves the estimated speed over ground in the longitudinal direction.

FIG. 15B illustrates another example range-Doppler map. In this case the radar transceiver 1210 detects the Doppler frequency associated with the target point as an average Doppler frequency associated with a range of distances corresponding to a volume below the road surface. Alternatively, the radar transceiver 1210 may perform a weighted combination of the strongest detections in the range 1550 to determine the Doppler frequency from which vehicle speed over ground is determined, where the weights can be configured as a function of detection strength.

It is noted that a wider antenna lobe will give a slightly different range-Doppler map appearance, and that the range-Doppler maps in FIG. 15A and in 15B are just schematic illustrations for explanatory purposes.

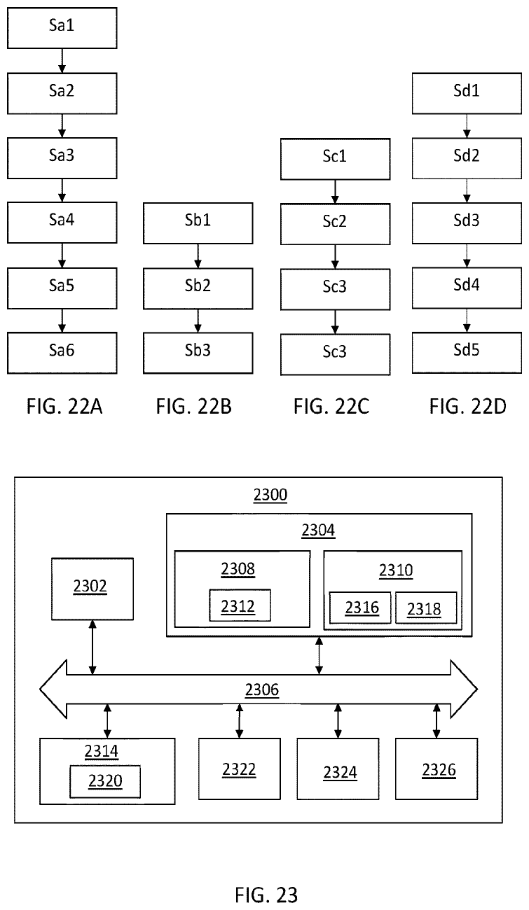

FIG. 22A is a flow chart that illustrates a computer-implemented method for determining velocity (vₓ and/or v_{y} and/or v_{z}) of a heavy-duty vehicle 100 with respect to a road surface 101 supporting the vehicle 100, which summarizes some of the above discussions. The method comprises:
configuring Sa1 a first radar transceiver 1240, a second radar transceiver 1250, and processing circuitry 1310, where the first radar transceiver 1240 is arranged to operate at a first carrier frequency f1 and where the second radar transceiver 1250 is arranged to operate at a second carrier frequency f2 that is higher than the first carrier frequency f1,
transmitting Sa2 a radar signal at the first carrier frequency f1 by the first radar transceiver 1240, and receiving a reflected radar signal at the first carrier frequency f1 from at least one location below the road surface 101, detecting Sa3 a first Doppler frequency based on the received reflected radar signal at the first carrier frequency f1,
transmitting Sa4 a radar signal at the second carrier frequency f2 by the second radar transceiver 1250, and receiving a reflected radar signal at the second carrier frequency f2 from at least one location on the road surface 101,
detecting Sa5 a second Doppler frequency based on the received reflected radar signal at the second carrier frequency f2, and
determining Sa6 the velocity (vₓ and/or v_{y} and/or v_{z}) of the heavy-duty vehicle 100 based on the first Doppler frequency and on the second Doppler frequency, i.e., by joint processing of the first Doppler frequency and on the second Doppler frequency.

FIG. 16 illustrates an interesting detection principle which can be used with any radar system that implements an antenna array capable of distinguishing between radar signal components arriving from different azimuth directions, including those radar systems comprising antenna arrays discussed herein. It is appreciated that a radar system is capable of detecting the range to an object, and also the radial velocity of the object relative to the radar transceiver. An object that moves on a circle centered on the radar transceiver antenna will look the same as an object that is located at the same range but not moving, due to the lack of radial velocity. The ground speed radar systems discussed herein measure radial velocity of the radar antenna system relative to the road surface 101 (or relative to some point below the road surface as discussed above in connection to, e.g., FIG. 12). In case the road surface moves tangentially with respect to the radar transceiver antenna, when looking in a direction a, then no radial velocity will be detected in that direction of arrival, since all the received radar signal energy 1630 from that direction will be located at zero Doppler frequency. This is illustrated in FIG. 16, where a radar system 1600 has been configured to determine at least one slip angle α of a heavy-duty vehicle 100 with respect to a ground plane 101 supporting the vehicle 100. The radar system 1600 may form part of one of the radar modules 110 on the example vehicle 100 discussed above in connection to FIG. 1, and preferably illuminates a portion of the road surface close to a wheel 310 on the vehicle 100. The radar system comprises at least one radar transceiver 1610 arranged to transmit and to receive a radar signal 115 via an antenna array 600, 650, such as those antenna arrays discussed above in connection to FIGS. 6A and 6B, over a range A of azimuth directions, which may be a continuous range of azimuth directions as in FIG. 8A or a set of discrete azimuth directions as in FIG. 8B. FIG. 17 illustrates an example vehicle with plurality of radar transceivers 1610 arranged to determine respective sideslip angles α₁, α₂, α₃.

According to some aspects, the antenna array 600, 650 is configured to emit the radar signal 115 in a transmission lobe simultaneously covering the range A of azimuth directions 1300.

The radar system 1600 also comprises processing circuitry 1620 arranged to evaluate a received non-zero Doppler power over the range A of azimuth directions. This non-zero Doppler power may be a sum of radar signal energy received at non-zero radial velocities, i.e., a summation over all ranges and Doppler frequencies different from the zero Doppler frequency. The processing circuitry 1620 is arranged to determine a slip angle α of the heavy-duty vehicle 100 as the azimuth direction associated with smallest received non-zero Doppler power over the range A of azimuth directions, as illustrated to the right in FIG. 16. In this particular azimuth direction a, a major part of the received radar signal energy 1630 is located at the zero Doppler frequency, as illustrated in the insert range-Doppler map 1640 in FIG. 16, since the motion is in direction orthogonal to the view angle of the radar 1610. It is appreciated that a maximization of received zero Doppler radar signal power over the range A of azimuth directions is equivalent to the aforementioned minimization of received non-zero Doppler power over the range A of azimuth directions.

The processing circuitry 1620 monitors radar signal energy reflected from the road surface 101 and incoming in different directions and evaluates the energy of the radar signal in terms of non-zero Doppler for different angles of arrival over the range A of azimuth directions. In case the processing circuitry finds an angle where the radar signal energy for non-zero Doppler is comparably small, then this angle is detected as the side slip angle of the vehicle. According to some aspects, the processing circuitry 1620 is arranged to evaluate the received non-zero Doppler power over the range A of azimuth directions for a given range s, corresponding to the range to the road surface 101 from the radar transceiver antenna. This may improve the reliability of the system, since is allows for filtering out some irrelevant radar signal energy which has not been reflected by the road surface but by some other object in vicinity of the radar transceiver.

According to some aspects, the antenna array 600, 650 is configured to emit the radar signal 115 in a transmission lobe which is more narrow than the range A of azimuth directions, and to sweep the transmission lobe over the range A of azimuth directions 1300. The processing circuitry can then evaluate received non-zero Doppler power over the range A of azimuth directions as the beam is swept over the range A of azimuth directions. The processing circuitry 1620 may even steer the transmission lobe to minimize the received non-zero Doppler power over the range A of azimuth directions.

According to some aspects, the processing circuitry 1620 is arranged to validate an estimated longitudinal and lateral velocity vₓ, v_{y} based on the determined slip angle α of the heavy-duty vehicle 100. The longitudinal and lateral velocity vₓ, v_{y} can be estimated by the processing circuitry or by some other module on the vehicle 100 using one or more of the techniques discussed herein. This velocity vector can then be compared to the sideslip angle determined by minimization of non-zero Doppler power and a check can be made to ensure that the two side slip angles at least approximately match. The radar system 110, 1600 is optionally arranged to trigger generation of a notification message in case a difference between the determined slip angle α and the angle of the estimated longitudinal and lateral velocity vₓ, v_{y} does not fulfil an acceptance criterion, such as a threshold or some form of statistical measure of similarity.

According to some aspects, the processing circuitry 1620 is arranged to obtain data associated with a steering angle of a wheel 310 of the heavy-duty vehicle 100, and to transform the determined slip angle α of the heavy-duty vehicle 100 into a coordinate system of the wheel 310 based on the data associated with the steering angle of the wheel 310. This transform basically amounts to rotating the slip angle measured by the radar system in dependence of the steering angle of the wheel.

The processing circuitry 1620 may furthermore be arranged to calibrate the determined slip angle α of the heavy-duty vehicle 100 based on input from at least one other sensor system, such as another ground radar sensor system or a set of wheel speed sensors of a wheel axle. The vehicle may for instance be operating in a condition where both wheels on an axle are free rolling and no significant wheel slip occurs. The measured slip angle should then be close to zero.

The processing circuitry 1620 may also be arranged to adapt a shape of an antenna lobe of the radar transceiver 1610 and/or an elevation angle γ of the antenna lobe of the radar transceiver 1610 in dependence of an operating condition of the vehicle 100, as discussed above. An adaptation of the range A of azimuth directions can be performed in order to capture the direction of zero Doppler received radar signal energy, or to focus the range A to a smaller more narrow range comprising the angle of arrival of interest, i.e., the angle where the energy of the received radar signal is focused around zero Doppler. The elevation angle γ of the antenna lobe may be adapted, e.g., to improve signal quality, where an increase in y normally improves estimated radial velocity, but also increases the size of the illuminated portion of road surface. An adaptation of elevation angle γ is in some cases preferably performed in combination with a decrease in elevation width of the antenna lobe in order to compensate for the increase in size of the illuminated portion of road surface.

FIG. 22B is a flow chart that illustrates a computer-implemented method for determining a slip angle α of a heavy-duty vehicle 100 with respect to a ground plane 101 supporting the vehicle 100, and which summarizes some of the operations discussed above. The method comprises
configuring Sb1 at least one radar transceiver 1610 to transmit and to receive a radar signal 115 via an antenna array 600, 650, over a range A of azimuth directions,
evaluating Sb2 a received non-zero Doppler power over the range A of azimuth directions, and
determining Sb3 the slip angle α of the heavy-duty vehicle 100 as the azimuth direction associated with smallest received non-zero Doppler power over the range A of azimuth directions.

FIG. 18 illustrates a radar transceiver system 1800 configured to operate in “virtual” Janus configuration. Janus configuration antennas for determining speed over ground of land-based or airborne vehicles are previously know, e.g., from U.S. Pat. Nos. 3,371,341A, 4,414,548A and EP0307338B1. However, these Janus configuration antennas are co-located at the same place on the vehicle. For estimation of vehicle motion state, it makes sense to distribute radar transceivers over the vehicle 100, as also illustrated in, e.g., FIG. 1 and in FIG. 4. A virtual Janus configuration ground speed radar arrangement is described herein which can be made resilient to pitch and/or roll motion by the vehicle, and which at the same time allows for radar transceivers to be spatially separated from each other on the vehicle by a significant distance, such as by more than one meter or even further.

Consider the example in FIG. 18 during hard braking of the vehicle 100 that causes a significant pitch motion P around the pitch axis 1840 of the vehicle 100, at a pitch rate ωₚ. The forward looking ground speed radar 1810 will give a radial velocity estimate vᵣ₁=a₁vₓ+b₁, where a₁ depends on the angle α₁ and where the bias b₁ is positive due to pitch motion P about the pitch axis 1840 of the vehicle 100 which causes relative motion of the antenna of the radar transceiver 1810 towards the road surface. With the geometry in FIG. 18,

$${v}_{r 1} \cdot cos ( {α}_{1} ) = {v}_{x} - {ω}_{P} \cdot h$$

$${v}_{r 1} \cdot sin ( {α}_{1} ) = {ω}_{P} \cdot {L}_{1}$$

The rearward looking radar 1820 will instead give a radial velocity estimate vᵣ₂=a₂vₓ+b₂, where a₂ is negative and depends on the angle α₂ and where the bias b₂ is also negative since now the pitch motion P causes relative motion of the radar transceiver 1820 away from the road surface. With the geometry in FIG. 18

$$- {v}_{r 2} \cdot cos ( {α}_{2} ) = {v}_{x} - {ω}_{P} \cdot h$$

$$- {v}_{r 2} \cdot sin ( {α}_{2} ) = {ω}_{P} \cdot {L}_{2}$$

In the special case of symmetry, where L₁=L₂, b₁=−b₂, so that

$${v}_{x} = \frac{{v}_{r 1} + {v}_{r 2}}{{a}_{1} + {a}_{2}}$$

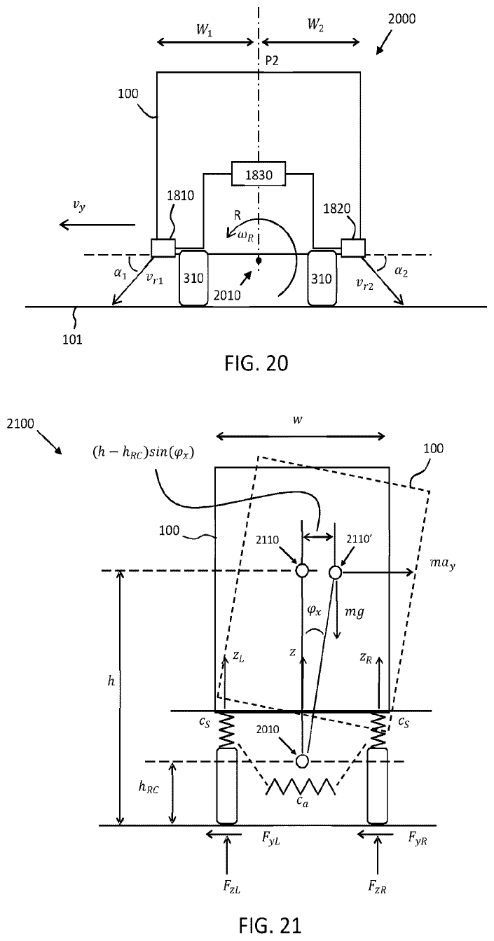

since the two biases cancel out. Thus, by suitably combining the elevations of the radars or jointly processing the first radial velocity vᵣ₁ and the second radial velocity vᵣ₂ based on the geometry of the installations of the first radar transceiver 1810 and of the second radar transceiver 1820 relative to the pitch axis 1840 location of the vehicle 100, the effects of a pitch motion P about the pitch axis 1840 of the vehicle 100 can be cancelled out, despite the spatial separations of the radar antennas on the vehicle 100. The same principles can be applied to cancel out the effects of roll motion about a roll axis 2010 of the vehicle 100, as illustrated in FIG. 20.

The equations related to the front radar 1810 and to the second radar 1820 can be written as

$${v}_{r 1} = \frac{1}{cos ( {α}_{1} )} \cdot {v}_{x} + \frac{- h}{cos ( {α}_{1} )} \cdot {ω}_{P}$$

$${v}_{r 2} = - \frac{{L}_{2}}{sin ( {α}_{2} )} \cdot {ω}_{P}$$

By summing these two equations, the following expression is obtained

$${v}_{r 1} + {v}_{r 2} = ( \frac{1}{cos ( {α}_{1} )} \cdot {v}_{x} + \frac{- h}{cos ( {α}_{1} )} \cdot {ω}_{P} ) \pm \frac{{L}_{2}}{sin ( {α}_{2} )} \cdot {ω}_{P} = \frac{1}{cos ( {α}_{1} )} \cdot {v}_{x} - ( \frac{h}{cos ( {α}_{1} )} + \frac{{L}_{2}}{sin ( {α}_{2} )} ) \cdot {ω}_{P}$$

In the special case where α₁ och α₂ are selected such that

$$\frac{h}{cos ( {α}_{1} )} + \frac{{L}_{2}}{sin ( {α}_{2} )} = 0$$

then

$${v}_{r 1} + {v}_{r 2} = \frac{1}{cos ( {α}_{1} )} \cdot {v}_{x}$$

i.e., independent of the pitch motion ωₚ. Thus, generally, it is possible to design the radar antenna configuration on a vehicle as a virtual Janus configuration with spatially separated antennas such that pitch motion still cancels out when summing two or more radar signals. The exact same principle can be applied for roll motion in a straightforward manner.

It is possible to extract four independent equations from the radar measurements in FIG. 18, and four unknown variables can therefore be determined. Hence, depending on what is known about the geometry and the motion state of the vehicle, it is possible to determine one or more additional parameters apart from, e.g., the speed over ground. For instance, if radar speeds vᵣ₁, vᵣ₂ are known (for instance since they are measured by the radars 1810, 1820) and their orientations α₁, α₂, and also a pitch center L₁, L₂, h location of the vehicle, then both the speed and the pitch motion can be determined, i.e., vₓ and ωₚ. Since the system is overdetermined a least-square solutions or the like can be used. Another option is use only one radar, e.g. radar 1810 to solve for both vₓ and ωₚ, as

$${ω}_{P} = \frac{{v}_{r 1} \cdot sin ( {α}_{1} )}{{L}_{1}}$$

$${v}_{x} = {v}_{r 1} \cdot ( cos ( {α}_{1} ) + \frac{h}{{L}_{1}} sin ( {α}_{1} ) )$$

The location of the pitch axis 1840 and/or the location of the roll axis 2010 relative to the positions and the pointing directions of the radar transceivers 1810, 1820 on the vehicle 100 can be predetermined, or at least obtained as a function of vehicle type and vehicle axle loads. However, by monitoring the estimated velocities by the two or more radar transceivers on the vehicle 100, it is also possible to estimate the location of the pitch axle and/or the location of the roll axis. A straightforward way to do this is to use a simple model of vehicle dynamics and sweep an assumed location of the pitch axis and/or roll axis to see where the radial velocity errors of the two or more radars match as the vehicle 100 pitches and as the vehicle 100 rolls, e.g., where the positive bias of the forward looking radar 1810 in FIG. 18 matches the negative bias of the rearward looking radar 1820 in FIG. 18.

With reference also to FIG. 19 and to FIG. 20, the virtual Janus configuration radar transceiver systems 1800, 2000 disclosed herein are configured to determine a velocity (vₓ and/or v_{y} and/or v_{z}) of a heavy-duty vehicle 100 with respect to a road surface 101 supporting the vehicle 100. The transceiver system comprises a first radar transceiver 1810, a second radar transceiver 1820, and processing circuitry 1830, where an installation of the first radar transceiver 1810 is geometrically different compared to an installation of the second radar transceiver 1820 relative to a pitch axis 1840 and/or a roll axis 2110 of the vehicle 100. The first radar transceiver 1810 and the second radar transceiver 1820 are preferably spatially separated from each other on the vehicle 100, such as by more than one meter, and preferably by several meters. In the example illustrated in FIG. 18 the first radar transceiver 1810 is located at the front of the vehicle 100 and pointing in the forward direction while the second radar transceiver 1820 is located at the rear of the vehicle and pointing backwards. The first radar transceiver 1810 is arranged to determine a first radial velocity vᵣ₁ relative to the road surface 101, and the second radar transceiver 1810 is arranged to determine a second radial velocity vᵣ₂ relative to the road surface 101. The two radar transceivers 1810, 1820 may be arranged at the same angle α relative to the road surface or at different angles α₁, α₂. The processing circuitry 1830 is configured to determine the velocity (vₓ and/or v_{y} and/or v_{z}) of the heavy-duty vehicle 100 by combining or jointly processing the first radial velocity vᵣ₁ and the second radial velocity vᵣ₂ based on the geometry of the installations of the first radar transceiver 1810 and of the second radar transceiver 1820 relative to the location of the pitch axis 1840 and/or the location of the roll axis 2110 on the vehicle 100. Thus, the differences in geometrical installation of the first and second radar transceiver are accounted for when combining the two radar signals, such that a pitch and/or a roll motion cancels out, allowing the radar transceiver to be pointed differently and also to be spatially separated from each other. The processing circuitry 1830 may also synchronize the two radar signals in time, in order to compensate for, e.g., transmission delays and the like.

Consider a simplified example, with reference to FIG. 18, where

$${v}_{r 1} = {a}_{1} {v}_{x} + {b}_{1} ( {ω}_{P} )$$

$${v}_{r 2} = {a}_{2} {v}_{x} + {b}_{2} ( {ω}_{P} )$$

It is normally straight forward to find the inverses to the functions b₁ and b₂, i.e.,

$${f}_{i} = {b}_{i}^{- 1}$$

FIG. 19 illustrates an example where a radar transceiver antenna is located at a distance rₚ from the pitch axis 1840. The angle between a line intersecting the pitch axis and the radar transceiver antenna is φ. The bias due to a pitch rotation op is then ωₚrₚ/sin(φ), i.e.,

$${v}_{r} = \frac{{v}_{x}}{cos ( α )} + \frac{{ω}_{P} {r}_{P}}{cos ( 90 - ϕ )} = \frac{{v}_{x}}{cos ( α )} + \frac{{ω}_{P} {r}_{P}}{sin ( ϕ )}$$

The bias due to pitch motion can generally be isolated by use of the functions ƒᵢ, as

$${f}_{1} ( {v}_{r 1} ) = {f}_{1} ( {a}_{1} * {v}_{x} ) + {f}_{1} ( {b}_{1} ( P ) ) = {f}_{1} ( {α}_{1} * {v}_{x} ) + P$$

$${f}_{2} ( {v}_{r 2} ) = {f}_{2} ( {a}_{2} * {v}_{x} ) + {f}_{2} ( {b}_{2} ( P ) ) = {f}_{2} ( {a}_{2} * {v}_{x} ) + P$$

such that

$${f}_{2} ( {v}_{r 2} ) - {f}_{1} ( {v}_{r 1} ) = {f}_{1} ( {a}_{1} * {v}_{x} ) - {f}_{2} ( {a}_{2} * {v}_{x} ) + P - P = {f}_{1} ( {a}_{1} * {v}_{x} ) - {f}_{2} ( {a}_{2} * {v}_{x} )$$

Since this is a measurement equation that only involves the single unknown variable vₓ, it can be determined from the radar measurements and from the measured radial velocities in a straightforward manner without impact from the pitch motion.

According to some aspects the processing circuitry 1830 is configured to obtain the location of the pitch axis 1840 and/or the location of the roll axis 2110 of the vehicle 100 as a preconfigured pitch axis 1840 and/or roll axis 2110 location. The pitch axis 1840 and/or roll axis 2110 location may, e.g., be determined from prior measurements or computer simulation and preconfigured as an LUT indexed by vehicle type and axle pressure. The radar transceiver system 1800, 2000 may also be configured to determine the location of the pivot axis 1840, 2110 and/or the roll axis of the heavy-duty vehicle 100. This can be achieved by simply moving an assumed pitch or roll axis location around in a vehicle model until a position is found where the biases due to pitch motion and/or due to roll motion at the different radar transceivers match, as will be discussed in more detail below.

According to an example, the first radar transceiver 1810 and the second radar transceiver 1820 have equal bore sight directions in elevation and opposite azimuth bore sight directions. This simplifies the adjustment to compensate for the spatial differences in installation. However, according to some other aspects, the processing circuitry 1830 is configured to compensate for differences in bore sight direction of the first radar transceiver 1810 and of the second radar transceiver 1820, which can be done in a straightforward manner that normally involves trigonometric calculations.

In the example of FIG. 18, the velocity of the heavy-duty vehicle 100 comprises a longitudinal velocity vₓ, and the first radar transceiver 1810 bore sight direction and the second radar transceiver 1810 bore sight direction are separated by a plane P1 extending laterally across the vehicle 100.

In the example of FIG. 20, the velocity of the heavy-duty vehicle 100 comprises a lateral velocity v_{y}, where the first radar transceiver 1810 bore sight direction and the second radar transceiver 1810 bore sight direction are separated by a plane P2 extending longitudinally across the vehicle 100.

FIG. 22C is a flow chart that illustrates a computer-implemented method for determining a velocity (vₓ and/or v_{y} and/or v_{z}) of a heavy-duty vehicle 100 with respect to a road surface 101 supporting the vehicle 100. The method comprises
providing Sc1 a first radar transceiver 1810, a second radar transceiver 1820, and processing circuitry 1830, where an installation of the first radar transceiver 1810 is geometrically different compared to an installation of the second radar transceiver 1820 relative to a pitch axis 1840 and/or a roll axis 2110 of the vehicle 100,
determining Sc2 a first radial velocity vᵣ₁ relative to the road surface 101 by the first radar transceiver 1810,
determining Sc3 a second radial velocity vᵣ₂ relative to the road surface 101 by the second radar transceiver 1810, and
determining Sc4 the velocity vₓ, v_{y} of the heavy-duty vehicle 100 by combining, i.e., jointly processing, the first radial velocity vᵣ₁ and the second radial velocity vᵣ₂ based on the geometry of the installations of the first radar transceiver 1810 and of the second radar transceiver 1820 relative to the pitch axis 1840 and/or the roll axis 2110 location of the vehicle 100.

The radar transceiver systems 1800, 2000 may as noted above also be configured to determine at least one pivot axis 1840, 2110 location on a heavy-duty vehicle 100. In this case the transceiver system comprises a first radar transceiver 1810, a second radar transceiver 1820, and processing circuitry 1830, where an installation of the first radar transceiver 1810 is geometrically different compared to an installation of the second radar transceiver 1820 on the vehicle 100, in relation to the pivot axis 1840, 2110. The first radar transceiver 1810 is arranged to determine a first radar output comprising a first radial velocity vᵣ₁ and/or first distance d₁ relative to the road surface 101, and the second radar transceiver 1810 is arranged to determine a second radar output comprising a second radial velocity vᵣ₂ and/or second distance d₂ relative to the road surface 101. The processing circuitry 1830 is configured to monitor the first radar output and the second radar output, and to determine the pivot axis 1840, 2110 location based on a vehicle model associated with the vehicle 100 and on the monitored first and second radar outputs. The at least one pivot axis 1840, 2110 location may comprise a vehicle pitch axis 1840 location and/or a vehicle roll axis 2110 location. The processing circuitry 1830 may for instance simply move an assumed pitch or roll axis location around in the vehicle model until a position is found where the biases due to pitch motion and/or due to roll motion at the different radar transceivers match. The analysis may also comprise a priori known approximate locations of the axes, obtained as function of, e.g., vehicle type, axle load, and operating condition.

With reference to FIG. 21, consider a vehicle 100 where all wheels are lumped into a left and a right wheel. The vehicle body stands on one lumped left and right spring. This means that all spring stiffnesses at one side have been summed together to a stiffness cs. A lumped antiroll connects the two sides with a stiffness ca. When the vehicle rolls, e.g., when turning, the vehicle body rotates along a roll center point 2010 on the roll axis, which position is uncertain end dependent on e.g., loading of the vehicle, tyre radius etc.

The vehicle body left, and right corner has a vertical distance z_{L} and z_{R} measured from the static condition when there is no body roll or heave motion. The springs have a static pretension of F_{zL0} and F_{zR0} respectively. The vertical tyre forces are found by spring and antiroll bar equations

$${F}_{zL} = {F}_{zL 0} - {c}_{s} \cdot {z}_{L} - {c}_{a} ( {z}_{L} - {z}_{R} )$$

$${F}_{zR} = {F}_{zR 0} - {c}_{s} \cdot {z}_{R} + {c}_{a} ( {z}_{L} - {z}_{R} )$$

With the vertical force equilibrium and roll moment equilibrium of the vehicle body are used to find the spring pretensions for static conditions

$${F}_{zL 0} + {F}_{zR 0} = mg$$

$${F}_{zL 0} \frac{w}{2} - {F}_{zR 0} \frac{w}{2} = 0$$

Force equilibrium of the body in lateral direction gives

$${F}_{y} - {ma}_{y} = 0$$

$${F}_{yL} + {F}_{yR} = {F}_{y}$$

Assuming no heave and pitch acceleration of the vehicle body, the vertical and moment equilibria give

$$- mg + {F}_{zL} + {F}_{zL} = m \dot{z} \approx 0$$

$${F}_{zL} \frac{w}{2} - {F}_{zR} \frac{w}{2} + {F}_{y} h + mg ( h - {h}_{RC} ) {φ}_{x} = {J}_{x} {\ddot{φ}}_{x} \approx 0$$

Distance compatibility of the corners give

$${z}_{L} = z + \frac{w}{2} {φ}_{x}$$

$${z}_{R} = z - \frac{w}{2} {φ}_{x}$$

By merging the above relationships, the center of gravity height h can be expressed as

$$h = \frac{( 2 {c}_{a} {w}^{2} + {c}_{s} {w}^{2} + 2 {mgh}_{RC} ) {φ}_{x}}{2 ( {ma}_{y} + mg {φ}_{x} )}$$

The parameters cₐ, c_{b} are parameters given when the suspension system is designed. If the suspension system is “active” i.e the suspension parameters are not constant, the suspension system should report the actual stiffness parameters. The term 2cₐw²+c_{b}w² is in fact the vehicle's so called roll stiffness.

The roll center height h_{RC}, roll angle φₓ, and lateral acceleration a_{y}, can all be estimated by a radar system arranged to measure radial distances, speeds, and accelerations according to the discussion herein and in the prior art. Alternatively, a lateral accelerometer can be used to obtain data indicative of the lateral acceleration a_{y}.

It is noted that the expression for the center of gravity height h contains a singularity when ma_{y}+mgφₓ=0. However, for steady state driving the sign of ay and ox is the same. Therefore, a good sanity check is to never apply the method when the signs of ay and ox are opposite. The expression for the center of gravity height h can become ill conditioned for small numbers in the denominator, making the quotient sensitive for e.g., bias in a_{y} or φₓ. Therefore, an excitation of roll may be desired in order to obtain accurate results. For example, when driving straight ahead h will not be computed correctly. The system may thus await significant roll motion and only then evaluate the expression for the center of gravity height h.

Consequently, according to some aspects, the processing circuitry 1830 is arranged to measure a roll angle φₓ of the vehicle 100 and a lateral acceleration a_{y} of the vehicle 100 based on the first radar output and the second radar output, and to determine a center of gravity height h based on the vehicle model. With reference to FIG. 21, the center of gravity height h can, e.g., be determined as

$$h = \frac{( 2 {c}_{a} {w}^{2} + {c}_{s} {w}^{2} + 2 {mgh}_{RC} ) {φ}_{x}}{2 ( {ma}_{y} + mg {φ}_{x} )}$$

where cₐ is a lumped anti-roll parameter of the vehicle model, w is a vehicle trackwidth of the model, cₛ is a lumped spring stiffness of the vehicle model, m is a vehicle mass of the vehicle model, g represents gravitational acceleration, and h_{RC} is the roll axis height over the road surface.

The center of gravity height h can be refined over time by using a suitable filtering technique, such as a Kalman filter or some type of low-pass filter to suppress noise and other disturbances. The filter is then preferably based on the above expression for center of gravity height h.

The processing circuitry 1830 can be configured to detect a change in the center of gravity height h, and to trigger an automated action by the vehicle 100 in response to detecting the change. The change may, e.g., be detected by comparing an instantaneous value for center of gravity height h to an average value. The action may comprise triggering generation of a notification message to one or more VMM functions as discussed above in connection to FIG. 5 and may also comprise an adjustment of a vehicle operating limit.

FIG. 22D is a flow chart that illustrates a computer-implemented method for determining at least one pivot axis 1840, 2110 location on a heavy-duty vehicle 100. The method comprises
providing Sd1 a first radar transceiver 1810, a second radar transceiver 1820, and processing circuitry 1830, where an installation of the first radar transceiver 1810 is geometrically different compared to an installation of the second radar transceiver 1820 on the vehicle 100, in relation to the pivot axis 1840, 2110,
determining Sd2 a first radar output comprising a first radial velocity vᵣ₁ and/or first distance d₁ relative to the road surface 101 by the first radar transceiver 1810,
determining Sd3 a second radar output comprising a second radial velocity vᵣ₂ and/or second distance d₂ relative to the road surface 101 by the second radar transceiver 1810,
monitoring Sd4 the first radar output and the second radar output by the processing circuitry 1830, and
determining Sd5 the pivot axis 1840, 2110 location based on a vehicle model associated with the vehicle 100 and on the monitored first and second radar outputs.

FIG. 23 is a schematic diagram of a computer system 2300 for implementing examples disclosed herein. The computer system 2300 is adapted to execute instructions from a computer-readable medium to perform these and/or any of the functions or processing described herein. The computer system 2300 may be connected (e.g., networked) to other machines in a LAN, an intranet, an extranet, or the Internet. While only a single device is illustrated, the computer system 2300 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 2300 may comprise at least one computing device or electronic device capable of including firmware, hardware, and/or executing software instructions to implement the functionality described herein. The computer system 2300 may include processing circuitry 2302 (e.g., processing circuitry including one or more processor devices or control units), a memory 2304, and a system bus 2306. The computer system 2300 may include at least one computing device having the processing circuitry 2302. The system bus 2306 provides an interface for system components including, but not limited to, the memory 2304 and the processing circuitry 2302. The processing circuitry 2302 may include any number of hardware components for conducting data or signal processing or for executing computer code stored in memory 2304. The processing circuitry 2302 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 2302 may further include computer executable code that controls operation of the programmable device.

The system bus 2306 may be any of several types of bus structures that may further interconnect to a memory bus (with or without a memory controller), a peripheral bus, and/or a local bus using any of a variety of bus architectures. The memory 2304 may be one or more devices for storing data and/or computer code for completing or facilitating methods described herein. The memory 2304 may include database components, object code components, script components, or other types of information structure for supporting the various activities herein. Any distributed or local memory device may be utilized with the systems and methods of this description. The memory 2304 may be communicably connected to the processing circuitry 2302 (e.g., via a circuit or any other wired, wireless, or network connection) and may include computer code for executing one or more processes described herein. The memory 2304 may include non-volatile memory 2308 (e.g., read-only memory (ROM), erasable programmable read-only memory (EPROM), electrically erasable programmable read-only memory (EEPROM), etc.), and volatile memory 2310 (e.g., random-access memory (RAM)), or any other medium which can be used to carry or store desired program code in the form of machine-executable instructions or data structures, and which can be accessed by a computer or other machine with processing circuitry 2302. A basic input/output system (BIOS) 2312 may be stored in the non-volatile memory 2308 and can include the basic routines that help to transfer information between elements within the computer system 2300.

The computer system 2300 may further include or be coupled to a non-transitory computer-readable storage medium such as the storage device 2314, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 2314 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 2314 and/or in the volatile memory 2310, which may include an operating system 2316 and/or one or more program modules 2318. All or a portion of the examples disclosed herein may be implemented as a computer program 2320 stored on a transitory or non-transitory computer-usable or computer-readable storage medium (e.g., single medium or multiple media), such as the storage device 2314, which includes complex programming instructions (e.g., complex computer-readable program code) to cause the processing circuitry 2302 to carry out actions described herein. Thus, the computer-readable program code of the computer program 2320 can comprise software instructions for implementing the functionality of the examples described herein when executed by the processing circuitry 2302. In some examples, the storage device 2314 may be a computer program product (e.g., readable storage medium) storing the computer program 2320 thereon, where at least a portion of a computer program 2320 may be loadable (e.g., into a processor) for implementing the functionality of the examples described herein when executed by the processing circuitry 2302. The processing circuitry 2302 may serve as a controller or control system for the computer system 2300 that is to implement the functionality described herein.

The computer system 2300 may include an input device interface 2322 configured to receive input and selections to be communicated to the computer system 2300 when executing instructions, such as from a keyboard, mouse, touch-sensitive surface, etc. Such input devices may be connected to the processing circuitry 2302 through the input device interface 2322 coupled to the system bus 2306 but can be connected through other interfaces, such as a parallel port, an Institute of Electrical and Electronic Engineers (IEEE) 1394 serial port, a Universal Serial Bus (USB) port, an IR interface, and the like. The computer system 2300 may include an output device interface 2324 configured to forward output, such as to a display, a video display unit (e.g., a liquid crystal display (LCD) or a cathode ray tube (CRT)). The computer system 2300 may include a communications interface 2326 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A radar system configured to determine at least one slip angle of a heavy-duty vehicle with respect to a ground plane supporting the vehicle, the radar system comprising
at least one radar transceiver arranged to transmit and to receive a radar signal via an antenna array, over a range of azimuth directions, and
processing circuitry arranged to evaluate a received non-zero Doppler power over the range of azimuth directions,
where the processing circuitry is arranged to determine the slip angle of the heavy-duty vehicle as the azimuth direction associated with smallest received non-zero Doppler power over the range of azimuth directions.

2. The radar system according to claim 1, where the processing circuitry is arranged to evaluate the received non-zero Doppler power over the range of azimuth directions for a given range.

3. The radar system according to claim 1, where a set of discrete azimuth directions constitutes the range of azimuth directions.

4. The radar system according to claim 1, where the range of azimuth directions is a continuous range of azimuth directions.

5. The radar system according to claim 1, where the antenna array is configured to emit the radar signal in a transmission lobe simultaneously covering the range of azimuth directions.

6. The radar system according to claim 1, where the antenna array is configured to emit the radar signal in a transmission lobe which is more narrow than the range of azimuth directions, and to sweep the transmission lobe over the range of azimuth directions.

7. The radar system according to claim 6, where the processing circuitry is arranged to steer the transmission lobe of the radar system to minimize the received non-zero Doppler power over the range of azimuth directions.

8. The radar system according to claim 1, where the processing circuitry is arranged to validate an estimated longitudinal and lateral velocity based on the determined slip angle of the heavy-duty vehicle.

9. The radar system according to claim 8, arranged to trigger generation of a notification message in case a difference between the determined slip angle and the angle of the estimated longitudinal and lateral velocity does not fulfil an acceptance criterion.

10. The radar system according to claim 1, wherein the processing circuitry is arranged to obtain data associated with a steering angle of a wheel of the heavy-duty vehicle, and to transform the determined slip angle of the heavy-duty vehicle into a coordinate system of the wheel based on the data associated with the steering angle of the wheel.

11. The radar system according to claim 1, wherein the processing circuitry is arranged to calibrate the determined slip angle of the heavy-duty vehicle based on input from at least one other sensor system.

12. The radar system according to claim 11, where the at least one other sensor system comprises wheel speed sensors of a wheel axle.

13. The radar transceiver system according to claim 1, where the processing circuitry is arranged to adapt a shape of an antenna lobe of the radar transceiver in dependence of an operating condition of the vehicle.

14. The radar transceiver system according to claim 1, where the processing circuitry is arranged to adapt an elevation angle of an antenna lobe of the radar transceiver in dependence of an operating condition of the vehicle.

15. A heavy-duty vehicle comprising a radar system according to claim 1.

16. The heavy-duty vehicle according to claim 15.

17. A computer-implemented method for determining a slip angle of a heavy-duty vehicle with respect to a ground plane supporting the vehicle, the method comprising
configuring at least one radar transceiver to transmit and to receive a radar signal via an antenna array, over a range of azimuth directions,
evaluating a received non-zero Doppler power over the range of azimuth directions, and
determining the slip angle of the heavy-duty vehicle as the azimuth direction associated with smallest received non-zero Doppler power over the range of azimuth directions.

18. A computer program product comprising program code for performing, when executed by the processing circuitry, the method of claim 17.

19. A non-transitory computer-readable storage medium comprising instructions, which when executed by the processing circuitry, cause the processing circuitry to perform the method of claim 17.
